SEQUENCE LISTING (42 sequences)

SEQ ID NO: 1 - DNA, 21 bp, Artificial Sequence
  Description of Artificial Sequence Synthetic primer
gtccctgccctttgtacacac

SEQ ID NO: 2 - DNA, 23 bp, Artificial Sequence
  Description of Artificial Sequence Synthetic primer
ttgatatgcttaagttcagcggg

SEQ ID NO: 3 - DNA, 710 bp, Rhodotorula glutinis
cgcccgtcgctactaccgattgaatggcttagtgaggcctccggattggctattgggagctcgcgagagcacctgactgccgagaagttgtacgaacttggtcatttagaggaagtaaaagtcgtaacaaggtttccgtaggtgaacctgcggaaggatcattagtgaatattagggtgtccaacttaacttggagcccgaccctcactttctaaccctgtgcatttgtcttgggtagtagcttgcgtcagcgagcgaatcccatttcacttacaaacacaaagtctatgaatgtaacaaatttataacaaaacaaaactttcaacaacggatctcttggctctcgcatcgatgaagaacgcagcgaaatgcgatacgtaatgtgaattgcagaattcagtgaatcatcgaatctttgaacgcaccttgcgctccatggtattccgtggagcatgcctgtttgagtgtcatgaattcttcaacccacctctttcttagtgaatcaggcggtgtttggattctgagcgctgctggcttcgcggcctagctcgctcgtaatgcattagcatccgcaatcgaacttcggattgactcggcgtaatagactattcgttgaggattctggtctctgactggagccgggtaaggttaaagggagctactaatcctcatgtctatcttgagattagacctcaaatcaggtaggacta

SEQ ID NO: 4 - DNA, 710 bp, Lipomyces tetrasporus; identical to SEQ ID NO: 3

SEQ ID NO: 5 - DNA, 707 bp, Rhodotorula glutinis
cgcccgtcgctactaccgattgaatggcttagtgaggcctccggattggctattgggagctcgcgagagcacccgactgccgagaagttgtacgaacttggtcatttagaggaagtaaaagtcgtaacaaggtttccgtaggtgaacctgcggaaggatcattagtgaatattagggcgtccaacttaacttggagcccgaactctcactttctaaccctgtgcatctgtttctggtcagtagctctctcgggagtgaacgccattcacttaaaacacaaagtctatgaatgtataaaatttataacaaaacaaaactttcaacaacggatctcttggctctcgcatcgatgaagaacgcagcgaaatgcgataagtaatgtgaattgcagaattcagtgaatcatcgaatctttgaacgcaccttgcgctctctggtattccggagagcatgcctgtttgagtgtcatgaaatcttcaaccctctcttttcttaatgaatcgagaggtgcttggatcctgagcgctgctggcttcggcctagctcgttcgtaatgcattagcatccgcaatcgaacttcggattgacttggcgtaatagactattcgctgaggattctggtctcgtaccagagccgggttgggttaaaggaagcttctaatcctaaaagtctaacttttgattagatctcaaatcaggtaggacta

SEQ ID NO: 6 - DNA, 707 bp, Lipomyces tetrasporus; identical to SEQ ID NO: 5

SEQ ID NO: 7 - DNA, 630 bp, Lipomyces tetrasporus
cgcccgtcgctactaccgattgaatggcttagtgaggccttcggactggctccagaaaatgggaaaccattatcaggagctggaaagttggtcaaacttggtcatttagaggaagtaaaagtcgtaacaaggtttccgtaggtgaacctgcggaaggatcattactgagtatttgtcttttaaagacatctctctatccataaactcttttttctaaaaagacatgatttacacaattagtctgaatgattatataaaaatcttcaaaactttcaacaacggatctcttggttctcgcatcgatgaagaacgcagcaaaatgcgataagtattgtgaattgcaggattttgtgaatcatcgaatttttgaacgcacattgcaccttctggtattccggagggtatacctgtttgagcgtcatttatatactcaaaactttgttttggtgatgggcacatatctggtgagagctagatttgcctgaaatatagtggtagagattgctacgagttatgcaagttagccaatgctattaagttaattcgttggtgaagcatgcggagctttagcggtcgccttccttaactattggaatttttctaattttgacctcaaatcaggcaggagta

SEQ ID NO: 8 - DNA, 641 bp, Lipomyces starkeyi
cgcccgtcgctactaccgattgaatggcttagtgagaccctcggattggcgttaggaagccggcaacggcatcctttggccgagaagttggtcaaacttggtcatttagaggaagtaaaagtcgtaacaaggtttccgtaggtgaacctgcggaaggatcattagtgattgcctttataggcttataactatatccacttacacctgtgaactgttctattacttgacgcaagtcgagtatttttacaaacaatgtgtaatgaacgtcgttttattataacaaaataaaactttcaacaacggatctcttggctctcgcatcgatgaagaacgcagcgaattgcgataagtaatgtgaattgcagaattcagtgaatcatcgaatctttgaacgcagcttgcgctctctggtattccggagagcatgcctgtttcagtgtcatgaaatctcaaccactagggtttcctaatggattggatttgggcgtctgcgatctctgatcgctcgccttaaaagagttagcaagtttgacattaatgtctggtgtaataagtttcactgggtccattgtgttgaagcgtgcttctaatcgtccgcaaggacaattactttgactctggcctgaaatcaggtaggacta

SEQ ID NO: 9 - DNA, 641 bp, Trichosporon montevideense; identical to SEQ ID NO: 8

SEQ ID NO: 10 - DNA, 456 bp, Yarrowia lipolytica
cgcccgtcgctactaccgattgaatggtttagtgagaccttgggagggcgagatgaggggggcaaccccttttgaacatccaaacttggtcaaacttgattatttagaggaagtaaaagtcgtaacaaggtttccgtaggtgaacctgcggaaggatcattattgattttatctatttctgtggatttctggtatattacagcgtcattttatctcaattataactatcaacaacggatctcttggctctcacatcgatgaagaacgcagcgaaccgcgatattttttgtgacttgcagatgtgaatcatcaatctttgaacgcacattgcgcggtatggcattccgtaccgcacggatggaggagcgtgttccctctgggatcgcattgctttcttgaaatggattttttaaactctcaattattacgtcatttcacctccttcatccgagatta

SEQ ID NO: 11 - DNA, 628 bp, Cryptococcus curvatus
cgcccgtcgctactaccgattgaatggcttagtgagatttctggattggcgttaggaagccggcaacggcatcctttggctgagaagttactcaaacttggtcatttagaggaagtaaaagtcgtaacaaggtttccgtaggtgaacctgcggaaggatcattagtgatttgccttcgggctaaactatatccataacacctgtgaactgttgattgacttcggtcaatatttttacaaacattgtgtaatgaacgtcatgttataataacaaatataactttcaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtgtcatgaaatctcaaccattagggtttcttaatggcttggatttggacgtttgccagtcaaatggctcgtcttaaaagagttagtgaatttaacatttgtcttctggcgtaataagtttcgctgggctgatagtgtgaagtttgcttctaatcgtccgcaaggacaattcttgaactctggcctcaaatcaggtaggacta

SEQ ID NO: 12 - DNA, 628 bp, Rhodotorula mucilaginosa; identical to SEQ ID NO: 11

SEQ ID NO: 13 - DNA, 628 bp, Trichosporon sp.
cgcccgtcgctactaccgattgaatggcttagtgagaccctcggattggcgttaagaagccggcaacggcatcttttggccgagaagttggtcaaacttggtcatttagaggaagtaaaagtcgtaacaaggtttccgtaggtgaacctgcggaaggatcattagtgaattgctctttgagcgttaaactatatccatctacacctgtgaactgttgattgacttcggtcaattacttttacaaacattgtgtaatgaacgtcatgttattataacaaaaataactttcaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtatcatgaaatctcaaccattagggtttcttaatggcttggatttgggcgctgccacttgcctggctcgccttaaaagagttagcgtattaacttgtcgatctggcgtaataagtttcgctggtgtagacttgagaagtgcgcttctaatcgtcctcggacaattcttgaactctggtctcaaatcaggtaggacta

SEQ ID NO: 14 - DNA, 716 bp, Sporobolomyces alborubescens
cgcccgtcgctactaccgattgaatggcttagtgaggcctccggattggctattgggagctcgcgagagcacccgactgccgagaagttgtacgaacttggtcatttagaggaagtaaaagtcgtaacaaggtttccgtaggtgaacctgcggaaggatcattagtgaatataggacgtccaacttaacttggagtccgaactctcactttctaaccctgtgcacttgtttgggatagtaactctcgcaagagagcgaactcctattcacttataaacacaaagtctatgaatgtattaaattttataacaaaataaaactttcaacaacggatctcttggctctcgcatcgatgaagaacgcagcgaaatgcgataagtaatgtgaattgcagaattcagtgaatcatcgaatctttgaacgcaccttgcgctccatggtattccgtggagcatgcctgtttgagtgtcatgaatacttcaaccctcctctttcttaatgattgaagaggtgtttggtttctgagcgctgctggcctttacggtctagctcgttcgtaatgcattagcatccgcaatcgaatttcggattgacttggcgtaatagactattcgctgaggaattctagtcttcggattagagccgggttgggttaaaggaagcttctaatcagaatgtctacattttaagattagatctcaaatcaggtaggacta

SEQ ID NO: 15 - DNA, 718 bp, Rhodotorula glutinis
cgcccgtcgctactaccgattgaatggcttagtgaggcctccggattggctattgggagctcgcgagagcacccgactgccgagaagttgtacgaacttggtcatttagaggaagtaaaagtcgtaacaaggtttccgtaggtgaacctgcggaaggatcattagtgaatctaggacgtccaacttaacttggagtccgaactctcactttctaaccctgtgcatctgttttaaaattggctagtagctcttcggagcgaaccaccatttttcacttatacaaacacaaagtctatgaatgtaaacaaatttataacaaaacaaaactttcaacaacggatctcttggctctcgcatcgatgaagaacgcagcgaaatgcgatacgtaatgtgaattgcagaattcagtgaatcatcgaatctttgaacgcaccttgcgctccttggtattccgaggagcatgcctgtttgagtgtcatgaaatcttcaacccacctctttcttagtgaatctggtggtgcttggtttctgagcgctgctctgcttcggcttagctcgttcgtaatgcattagcatccgcaaccgaaacttcggattgacttggcgtaatagactattcgctgaggattccagacttgttctggagccgagttgggttaaaggaagcttctaatcctaaagtctattttttgattagatctcaaatcaggtaggacta

SEQ ID NO: 16 - DNA, 693 bp, Rhodotorula glutinis
cgcccgtcgctactaccgattgaatggcttagtgagggctccggattggcttctgggagccggcaacggcacctagtcgctgagaagttggacgaacttggtcatttagaggaagtaaaagtcgtaacaaggtttccgtaggtgaacctgcggaaggatcattaatgaaatgcaaggacgctctttttagaggtccgacccaattcattttctcacactgtgcacacactactttttacaccatttttaacacttgaagtctaagaatgtaaacagtctcttaattgagcataaaatttaaacaaaactttcagcaacggatctcttggctctcccatcgatgaagaacgcagcgaaatgcgatacgtaatgtgaattgcagaattcagtgaatcatcgaatctttgaacgcaccttgcactctttggtattccgaagagtatgtctgtttgagtgtcatgaaactctcaacccccctgttttgtaatgaaccaggcgtgggcttggattatggctgctgccggcgtaattgtcgactcggctgaaatacacgagctacccatttcataagaaatagacggtttgactcggcgtaataacatatttcgctgaggacgtcacattctttacctagtggtgcttctaatgcgacatctaaactttaagctttagacctcaaatcagtcaggacta

SEQ ID NO: 17 - DNA, 640 bp, Trichosporon behrend
cgcccgtcgctactaccgattgaatggcttagtgagaccctcggattggcgttaggaagccggcaacggcatcctttggccgagaagttggtcaaacttggtcatttagaggaagtaaaagtcgtaacaaggtttccgtaggtgaacctgcggaaggatcattagtgattgccttcataggcttaaactatatccacatacacctgtgaactgttccaccacttgacgcaagtcgagtgtttttacaaacaatgtgtaatgaacgtcgttttattataacaaaataaaactttcaacaacggatctcttggctctcgcatcgatgaagaacgcagcgaattgcgataagtaatgtgaattgcagaattcagtgaatcatcgaatctttgaacgcagcttgcgctctctggtattccggagagcatgcctgtttcagtgtcatgaaatctcaaccactagggtttcctaatggattggatttgggcgtctgcgatctctgatcgctcgccttaaaagagttagcaagtttgacattaatgtctggtgtaataagtttcactgggtccattgtgttgaagcgtgcttctaatcgtccgcaaggacaattactttgactctggcctgaaatcaggtaggacta

SEQ ID NO: 18 - DNA, 476 bp, Geotrichum histeridarum
cgcccgtcgctactaccgatcgaatggcttagtgaggcttccggattgatttgggagagagggcgacttttttcctggaacgagaagctagtcaaacttggtcatttagaggaagtaaaagtcgtaacaaggtttccgtaggtgaacctgcggaaggatcattagaaaaatgcgatattagtggtttattttgctcgccgaaaggcaaacttttaacatacctacctttttttaactataaaaacttttaacaacggatctcttggttctcgcatcgatgaagaacgcagcgaattgcgatacgttttgtgaattgcagaagtgaatcatcaatctttgaacgcacattgcgcctggtggtattccgccaggcatacctgtttgagcgttgttctctctgggattgtctactttcctcaaagaaattaaacaaacaagtttgacacaacacctcaacctcagatcaggtaggacta

SEQ ID NO: 19 - DNA, 687 bp, Rhodotorula aurantiaca
cgcccgtcgctactaccgattgaatggcttagtgaggccttcggattggcttctgggagccggcaacggcacctagtcgctgagaagtttgacgaacttggtcatttagaggaagtaaaagtcgtaacaaggtttccgtaggtgaacctgcggaaggatcattaatgaattttaggacgttctttttagaagtccgaccctttcattttcttacactgtgcacacacttcttttttacacacacttttaacaccttagtataagaatgtaatagtctcttaattgagcataaataaaaacaaaactttcagcaacggatctcttggctctcgcatcgatgaagaacgcagcgaattgcgataagtaatgtgaattgcagaattcagtgaatcatcgaatctttgaacgcaccttgcactctttggtattccgaagagtatgtctgtttgagtgtcatgaaactctcaacccccctattttgtaatgagatgggtgtgggcttggattatggttgtctgtcggcgtaattgccggctcaactgaaatacacgagcaaccctattgaaataaacggtttgacttggcgtaataattatttcgctaaggacgctttcttcaaatataagaggtgcttctaattcgcttctaatagcatttaagctttagacctcaaatcagtcaggacta

SEQ ID NO: 20 - DNA, 687 bp, Cryptococcus curvatus; identical to SEQ ID NO: 19

SEQ ID NO: 21 - DNA, 636 bp, Trichosporon domesticum
cgcccgtcgctactaccgattgaatggcttagtgagacctccggattggcgttgagaagccggcaacggcatctcttggctgagaagttggtcaaacttggtcatttagaggaagtaaaagtcgtaacaaggtttccgtaggtgaacctgcggaaggatcattagtgattgccttaattggcttaaactatatccatctacacctgtgaactgtttgattgaatcttcggattcgattttatacaaacattgtgtaatgaacgtcattatattataacaaaaaaaaaactttcaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtgtcatgaaatctcaaccattagggtttcttaatggcttggatttggaggtttgccagtctgactggctcctcttaaaagagttagcaagttgaactattgctatctggcgtaataagtttcgctggaatggtattgtgaagcgtgcttctaatcgtcttcggacaattttttgactctggcctcaaatcaggtaggacta

SEQ ID NO: 22 - DNA, 711 bp, Rhodotorula toruloides
cgcccgtcgctactaccgattgaatggcttagtgaggcctccggattggctatcgggagctcgcgagagcacctgactgccgagaagttgtacgaacttggtcatttagaggaagtaaaagtcgtaacaaggtttccgtaggtgaacctgcggaaggatcattagtgaatattagggtgtccaacttaacttggagcccgaccctcactttctaaccctgtgcatttgtcttgggtagtagctcgtgtcagcgagcgaatcccatttcacttacaaacacaaagtctatgaatgtaacaaatttataacaaacaaaactttcaacaacggatctcttggctctcgcatcgatgaagaacgcagcgaaatgcgatacgtaatgtgaattgcagaattcagtgaatcatcgaatctttgaacgcaccttgcgctccatggtattccgtggagcatgcctgtttgagtgtcatgaattcttcaacccacctctttcttagtgaatcaggcggtgtttggattctgagcgttgctggcttcgcggcctagctcgctcgtaatgcattagcatccgcaatcgaacttcggattgactcggcgtaatagactattcgctgaggattctggtctctgactggagccgggtaagattaaaggaagctactaatcctcatgtctatcttttgagattagacctcaaatcaggtaggacta

SEQ ID NO: 23 - DNA, 753 bp, Rhodotorula terpendoidalis
cgcccgtcgctactaccgattgaatggcttagtgaggcctccggactggctattgggatctcgcgagagaacctgactgctgggaagttgtacgaacttggtcatttagaggaagtaaaagtcgtaacaaggtttccgtaggtgaacctgcggaaggatcattaatgaatattagggtgctcttttcatcaaagaggcctgaccttcattcttctaccctgtgcactattcaaacattcggcagttggtaatttggcttgtaaaagagccagacgactctgctgaattcactcttaaactctaaagtataagaatgttacaaataaaacaaataaaactttcaacaacggatctcttggctctcgcatcgatgaagaacgcagcgaaatgcgataagtaatgtgaattgcagaattcagtgaatcatcgaatctttgaacgcaccttgcgctcgctggtattccggcgagcatgcctgtttgagtgtcatgaaaacctcaacccttcaattccttgttgaattgtaaggtgtttggattctgaatgtttgctggcttgaagggcccttggctacttcaaaagcgaagctcattcgtaatacattagcatctcaatttcgaatattcggattgactcggcgtaatagactttattcgctgaggacaccttcacaaggtggccgaatttcgaggtagaagcttccaattcgatcaaaagtcactcttagtttagacctcagatcaggcaggacta

SEQ ID NO: 24 - DNA, 456 bp, Yarrowia lipolytica
cgcccgtcgctactaccgattgaatggtttagtgagaccttgggagggcgagatgaggggggcaaccccttttgaacatccaaacttggtcaaacttgattatttagaggaagtaaaagtcgtaacaaggtttccgtaggtgaacctgcggaaggatcattattgattttatctatttctgtggatttctggtatattacagcgtcattttatctcaattataactatcaacaacggatctcttggctctcacatcgatgaagaacgcagcgaaccgcgatattttttgtgacttgcagatgtgaatcatcaatctttgaacgcacattgcgcggtatggtattccgtaccgcacggatggaggagcgtgttccctctgggatcgcattgctttcttgaaatggattttttaaactctcaattattacgtcatttcacctccttcatccgagatta

SEQ ID NO: 25 - DNA, 709 bp, Rhodotorula glutinis
cgcccgtcgctactaccgattgaatggcttagtgaggcctccggattggctattgggagctcgcgagagcacctgactgccgagaagttgtacgaacttggtcatttagaggaagtaaaagtcgtaacaaggtttccgtaggtgaacctgcggaaggatcattagtgaatattagggtgtccaacttaacttggaacccgaccctcactttctaaccctgtgcatttgtcttgggtagtagcttgcgtcggcgagcgaatcccatttcacttacaaacacaaagtctatgaatgtaacaaatttataacaaacaaaactttcaacaacggatctcttggctctcgcatcgatgaagaacgcagcgaaatgcgatacgtaatgtgaattgcagaattcagtgaatcatcgaatctttgaacgcaccttgcgctccatggtattccgtggagcatgcctgtttgagtgtcatgaattcttcaacccacctatttcttagtgaatcaggcggtgtttggattctgagcgctgctggcctcacggcctagctcgctcgtaatgcattagcatccgcaatcgaacttcggattgactcggcgtaatagactattcgctgaggattctggtctctgactggagccgggtgagattaaaggaagctactaatcctcatgtctatcttgagattagacctcaaatcaggtaggacta

SEQ ID NO: 26 - DNA, 500 bp, Yarrowia lipolytica
gtccctgccctttgtacacaccgcccgtcgctactaccgattgaatggtttagtgagaccttgggagggcgagatgaggggggcaaccccttctgaacatccaaacttggtcaaacttgattatttagaggaagtaaaagtcgtaacaaggtttccgtaggtgaacctgcggaaggatcattattgattttatctatttctgtggatttctattctattacagcgtcattttatctcaattataactatcaacaacggatctcttggctctcacatcgatgaagaacgcagcgaaccgcgatattttttgtgacttgcagatgtgaatcatcaatctttgaacgcacattgcgcggtatggcattccgtaccgcacggatggaggagcgtgttccctctgggatcgcattgctttcttgaaatggattttttaaactctcaattattacgtcatttcacctccttcatccgagattacccgctgaacttaagcatatcaa

SEQ ID NO: 27 - DNA, 707 bp, Lipomyces tetrasporus
cgcccgtcgctactaccgattgaatggcttagtgaggcctccggattggctattgggagctcgcgagagcacctgactgctgagaagttgtacgaacttggtcatttagaggaagtaaaagtcgtaacaaggtttccgtaggtgaacctgcggaaggatcattagtgaatctaggacgtccaacttaacttggagtccgaaatctcactttctaaccctgtgcatctgttaattggaatagtagctcttcggagtgaaccaccattcacttataaaacacaaagtctatgaatgtatacaaatttataacaaaacaaaactttcaacaacggatctcttggctctcgcatcgatgaagaacgcagcgaaatgcgatacgtaatgtgaattgcagaattcagtgaatcatcgaatctttgaacgcaccttgcgctccttggtattccgaggagcatgcctgtttgagtgtcatgaaatcttcaacccacctctttcttagtgaatctggtggtgcttggtttctgagcgctgctctgcttcggcttagctcgttcgtaatgcattagcatccgcaaccgaacttcggattgacttggcgtaatagactattcgctgaggattctagtttactagagccgagttgggttaaaggaagctcctaatcctaaagtctattttttgattagatctcaaatcaggtaggacta

SEQ ID NO: 28 - DNA, 457 bp, Yarrowia lipolytica
cgcccgtcgctactaccgattgaatggtttagtgagaccttgggagggcgagatgaggggggcaaccccttctgaacatccaaacttggtcaaacttgattatttagaggaagtaaaagtcgtaacaaggtttccgtaggtgaacctgcggaaggatcattattgattttatctatttctgtggatttctattctattacagcgtcattttatctcaattataactatcaacaacggatctcttggctctcacatcgatgaagaacgcagcgaaccgcgatattttttgtgacttgcagatgtgaatcatcaatctttgaacgcacattgcgcggtatggcattccgtaccgcacggatggaggagcgtgttccctctgggatcgcattgctttcttgaaatggatttttttaaactctcaattattacgtcatttcacctccttcatccgagatta

SEQ ID NO: 29 - DNA, 1022 bp, Lipomyces tetrasporus
cgcccgtcgctactaccgattgaatggcttagtgaggccttcggactggctccagaaaatgggaaaccattatcaggagctggaaagttggtcaaacttggtcatttagaggaagtaaaagtcgtaacaaggtttccttccgtagcacttactgaagctttagcagcccgaaaaggcgaatgctagcgactataaataaatatggcgttcttaaatgctagtctctgattagaggcgacattgccaaattgcggggacatcctaaagatcttgataccaagctggtagtcgaaagacgccagtggccgagctaacagccctgggtatggtaataattcaagatatggaacaatgggtaatccgcagccaagtcctaaactacgcaagtagcatggatgcagttcacaggccaaatggtgatgggtagattactaaatctgcttaagatatggtcggtcccgctgtgagagcagatgggaagctacaaagcagactcgtgagtttgcgcaaacgtaactaaaaacgttccgtaggtgaacctgcggaaggatcattactgagtatttgtcttttaaagacatctctctatccataaactcttttttctaaaaagacatgatttacacaattagtctgaatgattatataaaaatcttcaaaactttcaacaacggatctcttggttctcgcatcgatgaagaacgcagcaaaatgcgataagtattgtgaattgcaggattttgtgaatcatcgaatttttgaacgcacattgcaccttctggtattccggagggtatacctgtttgagcgtcatttatatactcaaaacttcgttttggtgatgggcacatatctggtgagagctagatttgcctgaaatatagtggtagagattgctacgagttatgcaagttagccaatgctattaagttaattcgttggtgaagcatgcggagctttagtgatcgccttccttaactattggaatttttctaattttgacctcaaatcaggcaggagta

SEQ ID NO: 30 - DNA, 712 bp, Rhodosporidium sphaerocarpum
cgcccgtcgctactaccgattgaatggcttagtgaggcctccggaccggctattgggagctcgcgagagcacccgactgctgggaagttgtacgaacttggtcatttagaggaagtaaaagtcgtaacaaggtttccgtaggtgaacctgcggaaggatcattagtgaatataggacgtccaacttaacttggagtccgaactctcactttctaaccctgtgcatttgtttgggatagtagcctctcggggtgaactcctattcactcataaacacaaagtctatgaatgtatttaatttataacaaaataaaactttcaacaacggatctcttggctctcgcatcgatgaagaacgcagcgaaatgcgataagtaatgtgaattgcagaattcagtgaatcatcgaatctttgaacgcaccttgcgctccatggtattccgtggagcatgcctgtttgagtgtcatgaatacttcaaccctcctcttttctagtgaaagagaaggtgcttggtttctgagcgttttgctggcctcacggtcgagctcgctcgtaatgcattagcatccgcaatcgaacttcggattgacttggcgtaatagactattcgctgaggaattctaatcttcggattagagccgggttgggttaaaggaagcttctaatcctaatgtctatatttttagattagatctcaaatcaggtaggacta

SEQ ID NO: 31 - DNA, 631 bp, Trichosporon brassicae
cgcccgtcgctactaccgattgaatggcttagtgagacctccggattggcgttgagaagccggcaacggcatctcttggccgagaagttggtcaaacttggtcatttagaggaagtaaaagtcgtaacaaggtttccgtaggtgaacctgcggaaggatcattagtgattgccttaattggcttaaactatatccaactacacctgtgaactgttcgattgaatcttcgattcaattttacaaacattgtgtaaagaacgtcattagatcataacaaaaaaaaacttttaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtgtcatgaaatctcacacatcaaggtttcttgatgaagtggatttggaggttgccagtctaactggctcctcttaaaggagttagcatatttgattattgctgtctggcgtaataagtttcgctagtttggcattttgaagtgtgcttctaatcgtcttcggacaattttttgactctggcctcaaatcaggtaggacta

SEQ ID NO: 32 - DNA, 627 bp, Cryptococcus curvatus
cgcccgtcgctactaccgattgaatggcttagtgagatttccggattggcgttaggaagccggcaacggcatcctttggctgagaagctactcaaacttggtcatttagaggaagtaaaagtcgtaacaaggtttccgtaggtgaacctgcggaaggatcattagtgatttgccttcgggctaactatatccataacacctgtgaactgttgattgacttcggtcaatatttttacaaacattgtgtaatgaacgtcatgttataataacaaatataactttcaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtgtcatgaaatctcaaccattagggtttcttaatggcttggatttggacgtttgccagtcaaatggctcgtcttaaaagagttagtgaatttaacatttgtcttctggcgtaataagtttcgctgggctgatagtgtgaagtttgcttctaatcgtccgcaaggacaattcttgaactctggcctcaaatcaggtaggacta

SEQ ID NO: 33 - DNA, 627 bp, Lipomyces tetrasporus; identical to SEQ ID NO: 32

SEQ ID NO: 34 - DNA, 637 bp, Lipomyces starkeyi
cgcccgtcgctactaccgattgaatggcttagtgaggccttcggactggctccagaaaatgggaaaccattatcaggagctggaaagttggtcaaacttggtcatttagaggaagtaaaagtcgtaacaaggtttccgtaggtgaacctgcggaaggatcattactgagtatttgtcttttcaagacatctctctatccataaactcttttttttaaaaagacatgatttataacaattagtctgaatgattatttttaaatcttcaaaactttcaacaacggatctcttggttctcgcatcgatgaagaacgcagcaaattgcgataagtaatgtgaattgcaggattttgtgaatcatcgaatttttgaacgcacattgcaccttctggtattccggagggtatacctgtttgagcgtcatttatatactcaaaacttacgttttggtgatgggcacgtatctggcttctaagttagatttgcctgaaatatagcggtagaggtcgctagaagcgatgcaagttagccaatgctattaaagttaattcgttggtgacgcatgttgagcttttggtgaagtcttccttaattattggaatttttttctaattttgacctcaaatcaggcaggagta

SEQ ID NO: 35 - DNA, 457 bp, Yarrowia lipolytica
cgcccgtcgctactaccgattgaatggtttagtgagaccttgggagggcgagatgaggggggcaaccccttttgaacatccaaacttggtcaaacttgattatttagaggaagtaaaagtcgtaacaaggtttccgtaggtgaacctgcggaaggatcattattgattttatctatttctgtggatttctattctattacagcgtcattttatctcaattataactatcaacaacggatctcttggctctcacatcgatgaagaacgcagcgaaccgcgatattttttgtgacttgcagatgtgaatcatcaatctttgaacgcacattgcgcggtatggcattccgtaccgcacggatggaggagcgtgttccctctgggatcgcattgctttcttgaaatggatttttttaaactctcaattattacgtcatttcacctccttcatccgagatta

SEQ ID NO: 36 - DNA, 631 bp, Trichosporon loubieri
cgcccgtcgctactaccgattgaatggcttagtgagacctccggattggcgttgagaagccggcaacggcatctcttggccgagaagttggtcaaacttggtcatttagaggaagtaaaagtcgtaacaaggtttccgtaggtgaacctgcggaaggatcattagtgattgccatcttggcttaaactatatccatctacacctgtgaaccgtttgattgaatcttctgattcaattttacaaacattgtgtaatgaacgtcattagatcataataagaaaaaactttcaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtgtcatgaaatctcaaccattagggtttcttaatggcttggatttggaggttgccattctaaatggctcctcttaaaagagttagcgagtttaactattgctatctggcgtaataagtttcgctggaatggtattgtgaagcgcgcttctaatcgtcttcggacaattttttgactctggcctcaaatcaggtaggacta

SEQ ID NO: 37 - DNA, 476 bp, Geotrichum vulgare
cgcccgtcgctactaccgattgaatggcttagtgaggcttccggattgattagttggagagggagacttttctgactgaacgagaagctagtcaaacttggtcatttagaggaagtaaaagtcgtaacaaggtttccgtaggtgaacctgcggaaggatcattaaagatttaatattaattgtgaaattaaaacgatattaacaaaaaatcatacaatcaattataaaaaaaatcaaaacttttaacaatggatctcttggttctcgtatcgatgaagaacgcagcgaaacgcgatatttcttgtgaattgcagaagtgaatcatcagtttttgaacgcacattgcactttggggtatcccccaaagtatacttgtttgagcgttgtttctctcttggaattgcattgcttttctaaaaaatcgaatcaaattcgtttgaaacatccattcttcaacctcagatcaagtaggatta

SEQ ID NO: 38 - DNA, 710 bp, Rhodosporidium toruloides
cgcccgtcgctactaccgattgaatggcttagtgaggcctccggattggctattgggagctcgcgagagcacctgactgccgagaagttgtacgaacttggtcatttagaggaagtaaaagtcgtaacaaggtttccgtaggtgaacctgcggaaggatcattagtgaatattagggtgtccaacttaacttggagcccgaccctcactttctaaccctgtgcatttgtcttgggtagtagcttgcgtcagcgagcgaatcccatttcacttacaaacacaaagtctatgaatgtaacaaatttataacaaaacaaaactttcaacaacggatctcttggctctcgcatcgatgaagaacgcagcgaaatgcgatacgtaatgtgaattgcagaattcagtgaatcatcgaatctttgaacgcaccttgcgctccatggtattccgtggagcatgcctgtttgagtgtcatgaattcttcaacccacctctttcttagtgaatcaggcggtgtttggattctgagcgctgctggcttcgcggcctagctcgctcgtaatgcattagcatccgcaatcgaacttcggattgactcggcgtaatagactattcgctgaggattctggtctctgactggagccgggtaaggttaaagggagctactaatcctcatgtctatcttgagattagacctcaaatcaggtaggacta

SEQ ID NO: 39 - DNA, 707 bp, Rhodotorula glutinis
cgcccgtcgctactaccgattgaatggcttagtgaggcctccggattggctattgggagctcgcgagagcacctgactgctgagaagttgtacgaacttggtcatttagaggaagtaaaagtcgtaacaaggtttccgtaggtgaacctgcggaaggatcattagtgaatctaggacgtccaacttaacttggagtccgaactctcactttctaaccctgtgcatctgttaattggaatagtagctcttcggagtgaaccaccattcacttataaaacacaaagtctatgaatgtatacaaatttataacaaaacaaaactttcaacaacggatctcttggctctcgcatcgatgaagaacgcagcgaaatgcgatacgtaatgtgaattgcagaattcagtgaatcatcgaatctttgaacgcaccttgcgctccttggtattccgaggagcatgcctgtttgagtgtcatgaaatcttcaacccacctctttcttagtgaatctggtggtgcttggtttctgagcgctgctctgcttcggcttagctcgttcgtaatgcattagcatccgcaaccgaacttcggattgacttggcgtaatagactattcgctgaggattctagtttactagagccgagttgggttaaaggaagctcctaatcctaaagtctattttttgattagatctcaaatcaggtaggacta

SEQ ID NO: 40 - DNA, 707 bp, Lipomyces orientalis; identical to SEQ ID NO: 39

SEQ ID NO: 41 - DNA, 627 bp, Rhodotorula aurantiaca
cgcccgtcgctactaccgattgaatggcttagtgagatttccggattggcgttaggaagccggcaacggcatcctttggctgagaagctactcaaacttggtcatttaaaggaagtaaaagtcgtaacaaggtttccgtaggtgaacctgcggaaggatcattagtgatttgccttcgggctaactatatccataacacctgtgaactgttgattgacttcggtcaatatttttacaaacattgtgtaatgaacgtcatgttataataacaaatataactttcaacaacggatctcttggctctcgcatcgatgaagaacgcagcgaaatgcgataagtaatgtgaattgcagaattcagtgaatcatcgaatctttgaacgcaacttgcgctctctggtattccggagagcatgcctgtttgagtgtcatgaaatctcaaccattagggtttcttaatggcttggatttggacgtttgccagtcaaatggctcgtcttaaaagagttagtgaatttaacatttgtcttctggcgtaataagtttcgctgggctgatagtgtgaagtttgcttctaatcgtccgcaaggacaattcttgaactctggcctcaaatcaggtaggacta

SEQ ID NO: 42 - DNA, 899 bp, Torulaspora delbrueckii
cgcccgtcgctagtaccgattgaatggcttagtgaggcctcaggatctgcttagagaagggggcaactccatctcagagcggagaatctggtcaaacttggtcatttagaggaactaaaagtcgtaacaaggtttccgtaggtgaacctgcggaaggatcattagagaaatctatatgaatgaagttagaggacgtctaaagatactgtaagagaggatcaggttcaagaccagcgcttaattgcgcggttgcggcttggttcgccttttgcggaacatgtcttttctcgttgttaactctacttcaacttctacaacactgtggagttttctacacaacttttcttctttgggaagatacgtcttgtgcgtgcttcccagaggtgacaaacacaaacaactttttattattataaaccagtcaaaaccaatttcgttatgaaattaaaaatatttaaaactttcaacaacggatctcttggttctcgcatcgatgaagaacgcagcgaaatgcgatacgtaatgtgaattgcagaattccgtgaatcatcgaatctttgaacgcacattgcgccccttggtattccagggggcatgcctgtttgagcgtcatttccttctcaaacaatcatgtttggtagtgagtgatactctgtcaagggttaacttgaaattgctagcctgttatttggttgtgattttgctggcttggatgactttgtccagtctagctaataccgaattgtcgtattaggttttaccaacttcggcagactgtgtgttggctcgggcgctttaaagactttgtcgtaaacgatttatcgtttgtttgagcttttcgcatacgcaatccgggcgaacaatactctcaaagtttgacctcaaatcaggtaggaata

(19) United States
(12) Patent Application Publication
(10) Pub. No.: US 2011/0256268 A1
(43) Pub. Date: Oct. 20, 2011

(54) Oleaginous Yeast Food Compositions

(75) Inventors: Scott Franklin, San Diego, CA (US); John Piechocki, Redwood City, CA (US); Leslie M. Norris, San Rafael, CA (US); Stephen M. Decker, San Francisco, CA (US); Janice Wee, San Mateo, CA (US); Dana Zdanis, San Diego, CA (US)

(73) Assignee: Solazyme, Inc., South San Francisco, CA (US)

(21) Appl. No.: 13/087,305

(22) Filed: Apr. 14, 2011

Related U.S. Application Data
(60) Provisional application No. 61/324,285, filed on Apr. 14, 2010.
(60) Provisional application No. 61/333,716, filed on May 11, 2010.

(51) Int. Cl. A23L 1/30

(52) U.S. Cl. 426/62

(57) ABSTRACT

The invention provides novel oleaginous yeast biomass, yeast oil, food compositions comprising oleaginous yeast biomass, whole oleaginous yeast cells, and/or yeast oil in combination with one or more edible ingredients, and methods of making such compositions by combining oleaginous yeast biomass or yeast oil with other edible ingredients.

### CROSS-REFERENCE TO RELATED APPLICATIONS

This application claims the benefit under 35 U.S.C. 119(e) of U.S. Provisional Patent Application No. 61/324,285, filed Apr. 14, 2010, and U.S. Provisional Patent Application No. 61/333,716, filed May 11, 2010. Each of these applications is incorporated herein by reference in its entirety for all purposes.

### REFERENCE TO A SEQUENCE LISTING

This application includes a Sequence Listing, appended hereto as pages 1-14.

### FIELD OF THE INVENTION

The invention resides in the fields of microbiology, food preparation and human and animal nutrition.

### BACKGROUND OF THE INVENTION

As the human population continues to increase, there is a growing need for additional food sources, particularly food sources that are inexpensive to produce but nutritious. Moreover, the current reliance on meat as the staple of many diets, at least in the most developed countries, contributes significantly to the release of greenhouse gases, and there is a need for new foodstuffs that are equally tasty and nutritious, yet less harmful to the environment to produce.

Microorganisms such as yeast have been used in the human food chain for thousands of years. Species from the genus Saccharomyces (e.g., Saccharomyces cerevisiae, Saccharomyces pastorianus and Saccharomyces exiguus) has been used in baking (as an organic leavening agent) and fermenting alcoholic beverages such as beer, distilled alcohols, and wine. Yeast extracts (such as marmite, vegemite, promite and cenovis) have also been consumed since the early twentieth century, mainly as a food spread. These yeast extract products come usually as a dark paste and can be spread on bread, crackers or biscuits or used as flavoring in water, broth or porrige. Yeast extract products are suitable for vegans and vegetarians and are rich in B vitamins. Similarly, nutritional yeast consisting of deactivated yeast that has been dried into a powder or flake form is popular with vegans/vegetarians as a source of B vitamins and protein. Nutritional yeast is usually used as a cheese substitute and is sometimes used as a topping on popcorn. To date yeasts used in food have been used to provide protein or to ferment sugar into alcohols, but not to deliver lipids. Species from the genus Saccharomyces do not contain significant amounts of lipids compared to compositions from non-Saccharomyces species disclosed herein.

There remains a need for methods to produce foodstuffs from oleaginous yeast cheaply and efficiently, at large scale, particularly foodstuffs that are tasty and nutritious. The present invention meets these and other needs.

### SUMMARY OF THE INVENTION

The invention provides novel oleaginous yeast biomass, yeast oil, food compositions comprising oleaginous yeast biomass, oleaginous yeast flour, whole oleaginous yeast cells, and/or yeast oil in combination with one or more edible ingredients, and optionally at least one additional ingredient, and methods of making such compositions by combining oleaginous yeast biomass or yeast oil with other edible ingredients.

In a first aspect, the present invention is directed to a food ingredient composition comprising a dried egg product and oleaginous yeast flour, which is a homogenate of oleaginous yeast biomass containing predominantly or completely lysed cells in the form of a powder comprising at least 25%, 50%, or 75% by dry weight triglyceride oil, for formulation of a food product on addition of a liquid and optionally other edible ingredients. In some cases, the biomass is made under good manufacturing practice conditions.

In some embodiments, the dried egg product is dried whole eggs. In some cases, the dried egg product is dried egg whites. In some cases, the dried egg product is dried egg yolks. In some embodiments, the food ingredient composition is a powdered egg product, or a pancake or waffle mix.

In some embodiments, the oleaginous yeast flour is formed by micronizing oleaginous yeast biomass to form an emulsion and drying the emulsion. In some cases, the average size of particles in the oleaginous yeast flour is less than 100 μm. In some cases, the average size of particles in the oleaginous yeast flour is 1-15 μm.

In some embodiments, the oleaginous yeast biomass is 45-75% triglyceride oil by dry weight. In some cases, at least 50% by weight of the triglyceride oil is an 18:1 lipid and is contained in a glycerolipid form. In some cases, 60%-75% of the triglyceride oil is an 18:1 lipid in a glycerolipid form. In some embodiments, the oleaginous yeast biomass is derived from yeast of the Dikarya subkingdom.

In a second aspect, the present invention is directed to a food ingredient composition formed by combining an egg product and oleaginous yeast flour, which is a homogenate of oleaginous yeast biomass containing predominantly or completely lysed cells in the form of a powder comprising at least 25%, 50% or 75% by dry weight triglyceride oil, for formulation of a food product on addition of a liquid and optionally other edible ingredients. In some cases, the food ingredient composition is a pasta.

In a third aspect, the present invention is directed to a food ingredient composition comprising a liquid egg product and an oleaginous yeast flour slurry, wherein the oleaginous yeast flour is a homogenate of oleaginous yeast biomass containing predominantly or completely lysed cells in the form of a powder comprising at least 20%, 25%, 50% or 75%, 25%, 50% or 75% by dry weight triglyceride oil. In some cases, the liquid egg product is liquid whole eggs, liquid egg whites, liquid egg yolks and liquid egg substitute. In some embodiments, the food ingredient composition is for formulation of a scrambled egg product when heated.

In a fourth aspect, the present invention is directed to a method of preparing a food product comprising combining a food ingredient comprising a dried egg product and oleaginous yeast flour, which is a homogenate of oleaginous yeast biomass containing predominantly or completely lysed cells in the form of a powder comprising at least 20%, 25%, 50% or 75%, by dry weight triglyceride oil, with a liquid and optionally other edible ingredients and cooking. In some cases, the food product is a powdered egg product, or a pancake or waffle mix.

In a fifth aspect, the present invention is directed to a food composition formed by combining an egg product and oleaginous yeast flour or a slurry of oleaginous yeast flour, and at least one other edible ingredient and heating, wherein oleaginous yeast flour is a homogenate of oleaginous yeast biomass containing predominantly or completely lysed cells in the form of a powder comprising at least 20%, 25%, 50% or 75%, by dry weight triglyceride oil.

In some embodiments, the egg product is a liquid egg product. In some cases, the liquid egg product is liquid whole eggs, liquid egg yolks, liquid egg whites or liquid egg substitute. In some cases, the egg product is a dried egg product. In some cases, the dried egg product is dried whole eggs, dried egg yolks or dried egg whites.

In a sixth aspect, the present invention is directed to a food ingredient composition comprising an egg product and oleaginous yeast flour, which is a homogenate of oleaginous yeast biomass containing predominantly or completely lysed cells in the form of a powder comprising no more than 20%, 25%, 50% or 75% by dry weight triglyceride oil and at least 20%, 25%, 40%, 50% or 75% by dry weight protein, for formulation of a food product on addition of an edible liquid and optionally other edible ingredients.

In a seventh aspect, the present invention is directed to a gluten-free food product formed by combination of oleaginous yeast biomass comprising at least 20%, 25%, 50% or 75% triglyceride oil by dry weight and at least one other gluten-free flour or gluten-free grain product.

In some embodiments, the gluten-free flour or gluten-free grain product comprises at least one of the following amaranth flour, arrow root flour, buckwheat flour, rice flour, chickpea flour, cornmeal, maize flour, millet flour, potato flour, potato starch flour, quinoa flour, sorghum flour, soy flour, bean flour, legume flour, tapioca (cassava) flour, teff flour, artichoke flour, almond flour, acorn flour, coconut flour, chestnut flour, corn flour and taro flour. In some cases, the oleaginous yeast biomass is an oleaginous yeast flour. In some cases, the oleaginous yeast flour has an average particle size of between 1 and 100 μm. In some embodiments, the oleaginous yeast biomass is in the form of oleaginous yeast flour and further comprises a flow agent. In some cases, the oleaginous yeast biomass is in the form of oleaginous yeast flour and the flour further comprises an antioxidant. In some cases, the oleaginous yeast biomass is derived from yeast of the Dikarya subkingdom. In one embodiment, the yeast is Rhodotorula glutinis. In some embodiments, the oleaginous yeast biomass is predominantly lysed cells.

In some embodiments, the food product is a baked good, bread, cereal, cracker or pasta. In some cases, the product is a baked good and is selected from the group consisting of brownies, cakes, and cake-like products, and cookies. In some cases, a food-compatible preservative is added to the oleaginous yeast biomass. In some embodiments, the food product is free of oil or fat excluding oleaginous yeast oil contributed by the oleaginous yeast biomass. In some cases, the food product is free of egg yolks. In some embodiments, the food product is an uncooked product. In some embodiments, the food product is a cooked product.

In an eighth aspect, the present invention is directed to a gluten-free flour composition comprising a oleaginous yeast flour and at least one other gluten-free flour other than oleaginous yeast flour, wherein the oleaginous yeast flour comprises a homogenate of oleaginous yeast biomass containing predominantly or completely lysed cells in the form of a powder and contains at least 20%, 25%, 50% or 75% by dry weight triglyceride oil. In some embodiments, the at least one other gluten-free flour is selected from the group consisting of amaranth flour, arrow root flour, buckwheat flour, rice flour, chickpea flour, cornmeal, maize flour, millet flour, potato flour, potato starch flour, quinoa flour, sorghum flour, soy flour, bean flour, legume flour, tapioca (cassava) flour, teff flour, artichoke flour, almond flour, acorn flour, coconut flour, chestnut flour, corn flour and taro flour.

In some embodiments, the average size of particles of biomass in the oleaginous yeast flour is between 1 and 100 μM. In some cases, the oleaginous yeast flour has a moisture content of 10% or less or 5% or less by weight. In some cases, the oleaginous yeast biomass has between 45% and 70% by dry weight triglyceride oil. In some cases, the 60-75% of the oil is an 18:1 lipid in a glycerolipid form. In some embodiments, the gluten-free flour composition lacks visible oil. In some cases, the gluten-free flour composition further comprises a flow agent. In some embodiments, the oleaginous yeast biomass is derived from yeast of the Dikarya subkingdom. In one embodiment, the yeast is Rhodotorula glutinis.

In a ninth aspect, the present invention is directed to a method of reducing the symptoms of gluten intolerance. In one embodiment, the method comprises (a) substituting a gluten-containing food product in the diet of a subject having gluten intolerance with a food product of the same type produced by combining oleaginous yeast biomass comprising at least 20%, 25%, 50% or 75% triglyceride oil by dry mass and at least one other gluten-free food ingredient, wherein the food product of the same type is gluten free, and (b) providing the food product of the same type to a subject with gluten intolerance, whereby at least one symptom of gluten intolerance is reduced in the subject.

In a tenth aspect, the present invention is directed to a food product formed by baking a mixture of oleaginous yeast biomass having a triglyceride oil content of at least 20%, 25%, 50% or 75% by weight in the form of whole cell flakes or whole cell powder or a homogenate containing predominantly or completely lysed cells, and an edible liquid and at least one other edible ingredient. In some cases, the oleaginous yeast biomass is in the form of oleaginous yeast flour, which is a homogenate of oleaginous yeast biomass containing predominantly or completely lysed cells in powdered form. In some cases, the oleaginous yeast flour is a micronized homogenate of oleaginous yeast biomass. In some cases, the oleaginous yeast biomass is in the form of slurry of the homogenate. In some embodiments, the biomass is made under good manufacturing practice conditions.

In some embodiments, the food product has a water activity (Aw) of between 0.3 and 0.95. In some cases, the food product has at least 1.5 times higher fiber content compared to an otherwise identical conventional food product. In some cases, the food product is selected from the group consisting of a brownie, a cookie, a cake, and cake-like products, crackers, a bread, and snack chips. In some cases, the bread is a pizza crust, a breadstick, brioche, or a biscuit.

In some embodiments, the oleaginous yeast biomass is 45-75% triglyceride oil by dry weight. In some cases, at least 50% by weight of the triglyceride oil is an 18:1 lipid and is contained in a glycerolipid form. In some cases, 60%-75% of the triglyceride oil is an 18:1 lipid in a glycerolipid form. In some embodiments, the oleaginous yeast biomass is derived from yeast of the Dikarya subkingdom. In one embodiment, the yeast is a strain of Rhodotorula glutinis.

In an eleventh aspect, the present invention is directed to a food ingredient composition comprising oleaginous yeast biomass having a triglyceride oil content of at least 20%, 25%, 50% or 75% by weight in the form of whole cell flakes or whole cell powder or a homogenate containing predominantly or completely lysed cells and at least one other edible ingredient, wherein the food ingredient can be converted to a reconstituted food product by addition of liquid to the food ingredient composition and baking. In some embodiments, the food product further comprises a leavening agent selected from a chemical leavener and a biological leavener. In some cases, the oleaginous yeast biomass comprises at least 20%, 25%, 40%, 50% or 75% protein.

In a twelfth aspect, the present invention is directed to a method of making a baked product by (a) combining oleaginous yeast biomass having a triglyceride oil content of at least 20%, 25%, 50% or 75% by weight in the form of whole cell flakes or whole cell powder or a micronized homogenate in powder form, an edible liquid and at least one other edible ingredient, and (b) baking the mixture. In some embodiments, the baked product is a brownie, a cookie, a cake, a bread, a pizza crust, a breadstick, a cracker, a biscuit, pie crusts or snack chips. In some cases, the oleaginous yeast biomass is not combined with an edible liquid or other edible ingredient that is predominantly fat, oil, or egg.

In a thirteenth aspect, the present invention is directed to a beverage comprising oleaginous yeast biomass containing at least 20%, 25%, 50% or 75% by dry weight triglyceride oil and/or at least 20%, 25%, 40%, 50% or 75% by dry protein in the form of a whole cells or a homogenate containing predominantly or completely lysed cells and an edible liquid. In some cases, the edible liquid is soy mil, rice milk or almond milk. In some cases, the oleaginous yeast biomass is in the form of a micronized homogenate. In some cases, the average size of particles in the homogenate is less than 100 μm. In some cases, the average size of particles in the homogenate is 1-15 μm.

In some embodiments, the beverage is pasteurized. In some cases, the beverage further comprises an exogenous protein source and/or lactose. In some cases, the exogenous protein source is whey protein. In some embodiments, the beverage is free of lactose. In some cases, the beverage is selected from the group consisting of a milk, a juice, a smoothie, a nutritional beverage, an egg nog, and a meal replacement beverage.

In some embodiments, the oleaginous yeast biomass is 45-75% triglyceride oil by dry weight. In some cases, at least 50% by weight of the triglyceride oil is an 18:1 lipid and is contained in a glycerolipid form. In some cases, the yeast of the Dikarya subkingdom. In one embodiment, the yeast is a strain of Rhodotorula glutinis.

In a fourteenth aspect, the present invention is directed to a method of making a beverage comprising combining oleaginous yeast biomass in the form of whole cell flakes or powder or a micronized homogenate in the form of a powder having a triglycerol oil content of at least 25% and an edible liquid to form a beverage.

In a fifteenth aspect, the present invention is directed to a fermented food product comprising (a) oleaginous yeast biomass containing at least 20%, 25%, 50% or 75% by dry weight triglyceride oil and/or at least 20%, 25%, 40%, 50% or 75% by dry protein in the form of a whole cells or a homogenate containing predominantly or completely lysed cells, (b) an edible liquid, and (c) a live microbe suitable for use in food products. In some cases, the fermented food product is a yogurt. In some cases, the yogurt is in the form of a liquid beverage.

In a sixteenth aspect, the present invention is directed to a method of inducing satiety in a human, comprising administering a food product comprising oleaginous yeast biomass that is combined with one or more additional edible ingredients, wherein the oleaginous yeast biomass comprises at least 20%, 25%, 50% or 75% triglyceride oil by dry weight and at least 10% total dietary fiber by dry weight. In some cases, the oleaginous yeast biomass has between 45% and 70% by dry weight oil. In some cases, 60-75% of the triglyceride oil is an 18:1 lipid in a glycerolipid form.

In some embodiments, the one or more additional edible ingredient is selected from the group consisting of a grain, a fruit, a vegetable, protein, herbs and spices. In some cases, the food product is selected from the group consisting of egg products, bar, baked goods, breads, pasta, soups, beverages and desserts. In some cases, the food product is a nutritional beverage suitable as a meal replacement.

In some embodiments, the oleaginous yeast biomass is processed into a oleaginous yeast flour, which is a homogenate containing predominately or completely lysed cells in the form of a powder. In some cases, the average particle size of oleaginous yeast biomass in the flour is between 1 and 100 μm. In some cases, the particle size is less than about 100 μm, less than about 75 μm, less than about 50 μm, less than about 25 μm, or less than about 10 μm. In some cases, the flour further comprises an antioxidant. In some cases, the oleaginous yeast biomass is derived from a yeast of the Dikarya subkingdom. In one embodiment, the yeast is Rhodotorula glutinis. In some embodiments, the oleaginous yeast biomass is derived from yeast cultured and processed under good manufacturing practice (GMP) conditions. In some cases, the food product comprises at least 10% w/w oleaginous yeast biomass.

In a seventeenth aspect, the present invention is directed to a method of inducing satiety, comprising replacing one or more conventional food products in a diet of a subject with one or more oleaginous yeast-containing food products of the same type, wherein the oleaginous yeast-containing food product(s) of the same type contains oleaginous yeast biomass comprising at least 20%, 25%, 50% or 75% triglyceride oil by dry weight and at least 10% total dietary fiber by dry weight, wherein calories consumed by the subject are the same or lower on the replacement diet and the subject has increased satiety.

In an eighteenth aspect, the present invention is directed to a method of inducing satiety in a subject comprising administering a oleaginous yeast food product to the subject, wherein the oleaginous yeast food product is comparable to a conventional food product except that some or all of oils, fats, or eggs in the conventional food product are replaced with oleaginous yeast biomass comprising at least 20%, 25%, 50% or 75% triglyceride oil by dry weight and at least 10% total dietary fiber by dry weight.

In a nineteenth aspect, the present invention is directed to an oleaginous yeast flour comprising a homogenate of oleaginous yeast biomass containing predominantly or completely lysed cells in the form of a powder comprising at least 20%, 25%, 50% or 75% by dry weight triglyceride oil. In some cases, the average size of particles in the powder is less than 100 μm. In some cases, the average size of particles in the powder is 1-15 μm. In some embodiments, the powder is formed by micronizing hydrated oleaginous yeast biomass to form an emulsion and drying the emulsion.

In some embodiments, the oleaginous yeast flour has a moisture content of 10% or less or 5% or less by weight. In some cases, the biomass comprises between 45% and 70% by dry weight triglyceride oil. In some cases, 60%-75% of the triglyceride oil is an 18:1 lipid in a glycerolipid form. In some embodiments, the oleaginous yeast flour is in the form of a food ingredient composition, wherein the oleaginous yeast flour is combined with one or more additional edible ingredients that is a grain, fruit, vegetable, protein, herbs, spices, or one or more ingredients for preparation of a salad dressing, egg product, baked good, bread, pasta, sauce, soup, beverage, frozen dessert, butter or spread. In some cases, the oleaginous yeast flour lacks visible oil. In some cases, the oleaginous yeast flour further comprises a flow agent. In some cases, the oleaginous yeast flour further comprises an antioxidant. In some embodiments, the biomass is derived from a single strain of oleaginous yeast. In some cases, the biomass is derived from yeast of the Dikarya subkingdom. In one embodiment, the yeast is Rhodotorula glutinis. In some cases, the oleaginous yeast biomass is derived from yeast cultured and processed under good manufacturing practice (GMP) conditions.

In a twentieth aspect, the present invention is directed to a food ingredient composition comprising or formed by combining (a) at least 0.5% w/w oleaginous yeast flour, wherein the oleaginous yeast flour is a homogenate containing predominantly or completely lysed oleaginous yeast cells in the form of a powder comprising at least 20%, 25%, 50% or 75% by weight triglyceride oil, and (b) at least one other edible ingredient, wherein the food ingredient composition can be converted into a reconstituted food product by addition of a liquid to the food ingredient composition.

In some embodiments, the food ingredient composition is a dry pasta. In some cases, the food ingredient composition can be converted into a reconstituted food product by the addition of liquid followed by baking. In some cases, the reconstituted food product is a liquid food product. In some embodiments, the food ingredient composition can be converted into the reconstituted food product by a process including subjecting the product of reconstitution to shear forces.

In some embodiments, the average size of particles of oleaginous yeast biomass in the liquid food product is between 1 and 15 μm. In some cases, the reconstituted food product is an emulsion. In some cases, the reconstituted food product is a salad dressing, soup, sauce, beverage, butter or spread. In some cases, the reconstituted food product contains no oil or fat other than oil from the oleaginous yeast biomass. In some cases, the amount of oleaginous yeast flour in the reconstituted food product is 0.25-1 times the weight of oil and/or fat in a conventional food product of the same type as the reconstituted food product. In some cases, the average size of particles of oleaginous yeast biomass is less than 100 μm. In some cases, the average size of particles of oleaginous yeast biomass is 1-15 μm. In some embodiments, the food ingredient composition has a moisture content of 10% or less or 5% or less by weight. In some cases, the oleaginous yeast biomass comprises between 45% and 65% by dry weight triglyceride oil. In some cases, 60%-75% of the triglyceride oil is an 18:1 lipid in a glycerolipid form.

In a twenty first aspect, the present invention is directed to a method of making a oleaginous yeast flour by (a) providing oleaginous yeast cells containing at least 20%, 25%, 50% or 75% by dry weight triglyceride oil, (b) disrupting the cells and reducing the particle size to produced an aqueous homogenate, and (c) drying the homogenate to produce oleaginous yeast flour comprising at least 20%, 25%, 50% or 75% by dry weight triglyceride oil.

In a twenty second aspect, the present invention is directed to a method of making a food product from oleaginous yeast flour by (a) determining an amount of oleaginous yeast flour to include in the food product based an amount of oil, fat or eggs in a conventional form of the food product, wherein the oleaginous yeast flour is a homogenate of oleaginous yeast biomass containing predominantly or completely lysed cells in the form of a powder comprising at least 20%, 25%, 50% or 75% by dry weight triglyceride oil, and (b) combining the amount of oleaginous yeast flour with one or more edible ingredients and less than the amount of oil, fat or eggs present in the conventional form of the food product to form the food product from the oleaginous yeast flour.

In a twenty third aspect, the present invention is directed to a food or food ingredient composition containing at least 10% by weight of a homogenate of oleaginous yeast biomass containing predominantly or completely lysed cells comprising at least 20%, 25%, 50% or 75% by dry weight triglyceride oil emulsified in an edible liquid. In some cases, the composition is a sauce, a mayonnaise, a soup, or a dressing.

In some embodiments, the composition is free of oil and fat except for oil in the oleaginous yeast biomass. In some cases, the composition contains less than 25% oil or fat by weight excluding oil contributed by the biomass. In some cases, the composition contains less than 10% oil or fat by weight excluding oil contributed by the biomass. In some cases, the composition is an oil in water emulsion. In some cases, the composition is a water in oil emulsion. In some cases, the biomass is made under good manufacturing process conditions. In some cases, the oleaginous yeast biomass is 45-75% triglyceride oil by dry weight. In some cases, at least 50% by weight of the triglyceride oil is an 18:1 lipid and is contained in a glycerolipid form. In some embodiments, the yeast is of the Dikarya subkingdom. In one embodiment, the yeast is a strain of Rhodotorula glutinis.

In a twenty fourth aspect, the present invention is a slurry formed by dispersing oleaginous yeast flour, which is a homogenate of oleaginous yeast biomass containing predominantly or completely lysed cells comprising at least 20%, 25%, 50% or 75% by dry weight triglyceride oil in powder form in an aqueous solution, wherein the oleaginous yeast flour constitutes 10-50% by weight of the slurry. In some cases, the biomass has an oil content of 5-55% triglyceride oil by dry weight.

In a twenty fifth aspect, the present invention is a method of making a food product including oleaginous yeast biomass by (a) determining an amount of oleaginous yeast biomass to include in the food product based an amount of oil, fat or eggs in a conventional form of the food product, wherein the oleaginous yeast biomass comprises at least 20%, 25%, 50% or 75% by dry weight triglyceride oil, and (b) combining the amount of oleaginous yeast biomass with one or more edible ingredients and less than the amount of oil, fat or eggs present in the conventional form of the food product to form the food product including oleaginous yeast biomass.

In a twenty sixth aspect, the present invention is directed to a purified oleaginous yeast triglyceride oil suitable for human consumption comprising at least 50% oleic oil, wherein the oleaginous yeast oil is prepared under good manufacturing conditions. In some cases, the triglyceride oil is packaged in a bottle or aerosol spray can that is suitable for use in cooking applications. In some cases, the oil is packaged in a volume greater than 50 mL of oil product. In some embodiments, the oil is derived from yeast of the Dikarya subkingdom. In some cases, the oleaginous yeast triglyceride oil further comprises an added antioxidant.

In a twenty seventh aspect, the present invention is directed to a food spread comprising an oleaginous yeast triglyceride oil and a liquid, wherein the oil and the liquid are formed into a stable emulsion. In some cases, the food spread further comprises an emulsifier. In some cases, the food spread is spreadable at ambient temperature. In some embodiments, the food spread is spreadable at 5-10° C.

In a twenty eighth aspect, the present invention is directed to a margarine formed by subjecting purified oleaginous yeast triglyceride oil produced under good manufacturing practice conditions to a chemical or enzymatic reaction, whereby the margarine is produced. In some cases, the chemical reaction is hydrogenation. In some cases, the chemical or enzymatic reaction is interesterification with glycerolipids of a different lipid profile from the oleaginous yeast triglyceride oil. In some embodiments, the glycerolipids of a different lipid profile from the oleaginous yeast triglyceride oil are from one or more of oils selected from the group consisting of soy, rapeseed, canola, palm, palm kernel, coconut, corn, olive, sunflower, cotton seed, cuphea, peanut, camelina sativa, mustard seed, cashew nut, oats, lupine, kenaf, calendula, hemp, coffee, linseed, hazelnut, euphorbia, pumpkin seed, coriander, camellia, sesame, safflower, rice, tung oil tree, cocoa, copra, pium poppy, castor beans, pecan, jojoba, jatropha, macadamia, Brazil nuts, and avocado.

In a twenty ninth aspect, the present invention is directed to a purified oleaginous yeast triglyceride oil suitable for human consumption comprising at least 10% 16:1 oil in triglyceride form, wherein the oleaginous yeast oil is prepared under good manufacturing conditions. In some cases, the triglyceride oil is packaged in a bottle or aerosol spray can that is suitable for use in cooking applications. In some embodiments, the oil is packaged in a volume greater than 50 mL of oil product. In some cases the oil is derived from a yeast of the Dikarya subkingdom. In some cases, the yeast is of the species Torulaspora delbruekii or Yarrowia lipolytica. In some cases, the oil further comprises an added antioxidant.

Yet another aspect of the invention provides a food composition comprising at least 0.1% w/w oleaginous yeast biomass and one or more other ingredient. The oleaginous biomass comprises at least about 20%, 25%, 30%, 35%, 40%, 45%, 50% or 75% oil by dry weight. The food composition may comprise more than 0.1% w/w oleaginous yeast biomass, more than 0.25% w/w oleaginous yeast biomass, more than 0.5% w/w oleaginous yeast biomass, more than 1% w/w oleaginous yeast biomass, more than 2.5% w/w oleaginous yeast biomass, more than 5% w/w oleaginous yeast biomass, more than 20% w/w oleaginous yeast biomass, more than 0.1% w/w oleaginous yeast biomass or more than 20%, 25%, 50% or 75% w/w oleaginous yeast biomass.

In some cases, the oleaginous yeast biomass comprises oil having a lipid profile comprising at least 10%, at least 15%, at least 20%, at least 25%, at least 30%, at least 35%, or at least 40%, or more C16:1.

Another aspect of the invention provides a method of making a food composition comprising combining oleaginous yeast biomass comprising at least about 20% by weight oleaginous yeast oil with at least one other ingredient. In some cases, the biomass comprises at least about 25%, 30%, 35%, 40%, 45%, 50%, or 75% by weight oleaginous yeast oil, or other values or ranges of oil, by weight, as set forth herein.

Another aspect of the invention provides a method of making a food composition by determining the amount of non-oleaginous yeast oil, non-oleaginous yeast fat or egg in a conventional food product. All or a portion of the non-oleaginous yeast oil, non-oleaginous yeast fat or egg can be replaced or supplemented with a specified amount of oleaginous yeast biomass. In one embodiment, no non-oleaginous yeast oil, non-oleaginous yeast fat or egg is added to the food composition. Alternatively, the amount of oleaginous yeast biomass used in the food composition is from about 0.25 times to about 4 times the mass or volume of the non-oleaginous yeast oil, non-oleaginous yeast fat or egg in the conventional food product. In some cases, no non-oleaginous yeast oil, non-oleaginous yeast fat, or egg is added to the food composition.

A further aspect of this invention provides oleaginous yeast biomass and oleaginous yeast flour wherein the oleaginous yeast is cultivated and/or propogated heterotrophically.

These and other aspects and embodiments of the invention are described in the accompanying drawings, a brief description of which immediately follows, and in the detailed description of the invention below, and are exemplified in the examples below. Any or all of the features discussed above and throughout the application can be combined in various embodiments of the present invention.

### BRIEF DESCRIPTION OF THE DRAWINGS

FIG. 1 shows (A) control yellow cake and (B) yellow cake containing lipid-rich oleaginous yeast biomass in place of butter and egg yolks and (C) cross-section of the yellow cake containing lipid-rich oleaginous yeast biomass.

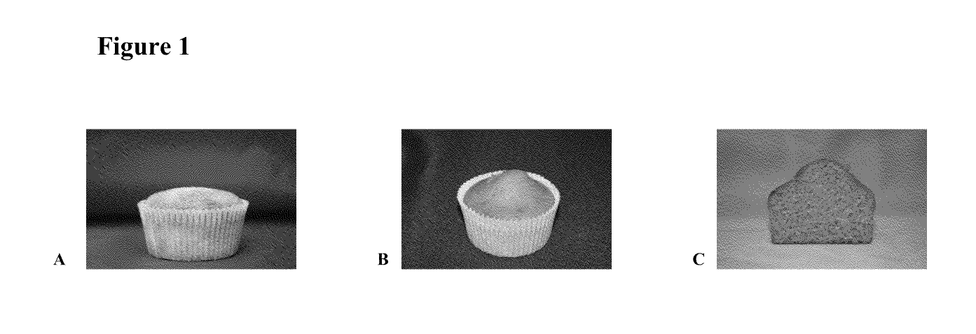

FIG. 2 summarizes the results of a carbon utilization screen with oleaginous yeast species that is described in Example 5.

### DETAILED DESCRIPTION OF THE INVENTION

This detailed description of the invention is divided into sections and subsections for the convenience of the reader. Section I provides definitions for various terms used herein. Section II, in parts A-D, describes methods for preparing oleaginous yeast biomass, including suitable organisms (A), culture conditions (B), concentration conditions (C), and chemical composition of the biomass produced in accordance with the invention (D). Section III, in parts A-C, describes methods for processing the oleaginous yeast biomass into yeast flour of the invention. Section IV describes various foods of the invention and methods of combining oleaginous yeast biomass with other food ingredients. Section V describes various examples.

All of the processes described herein can be performed in accordance with GMP or equivalent regulations. In the United States, GMP regulations for manufacturing, packing, or holding human food are codified at 21 C.F.R. 110. These provisions, as well as ancillary provisions referenced therein, are hereby incorporated by reference in their entirety for all purposes. GMP conditions in the Unites States, and equivalent conditions in other jurisdictions, apply in determining whether a food is adulterated (the food has been manufactured under such conditions that it is unfit for food) or has been prepared, packed, or held under unsanitary conditions such that it may have become contaminated or otherwise may have been rendered injurious to health. GMP conditions can include adhering to regulations governing: disease control; cleanliness and training of personnel; maintenance and sanitary operation of buildings and facilities; provision of adequate sanitary facilities and accommodations; design, construction, maintenance, and cleanliness of equipment and utensils; provision of appropriate quality control procedures to ensure all reasonable precautions are taken in receiving, inspecting, transporting, segregating, preparing, manufacturing, packaging, and storing food products according to adequate sanitation principles to prevent contamination from any source; and storage and transportation of finished food under conditions that will protect food against physical, chemical, or undesirable microbial contamination, as well as against deterioration of the food and the container.

### I. DEFINITIONS

Unless defined otherwise below, all technical and scientific terms used herein have the meaning commonly understood by a person skilled in the art to which this invention belongs. General definitions of many of the terms used herein may be found in Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991).

“Area Percent” refers to the determination of the area percent of chromatographic, spectroscopic, and other peaks generated during experimentation. The determination of the area under the curve of a peak and the area percent of a particular peak is routinely accomplished by one of skill in the art. For example, in FAME GC/FID detection methods in which fatty acid molecules in the sample are converted into a fatty acid methyl ester (FAME) a separate peak is observed for a fatty acid of 14 carbon atoms with no unsaturation (C14:0) compared to any other fatty acid such as C14:1. The peak area for each class of FAME is directly proportional to its percent composition in the mixture and is calculated based on the sum of all peaks present in the sample (i.e. [area under specific peak/total area of all measured peaks]×100). When referring to lipid profiles of oils and cells of the invention, “at least 4% C8-C14” means that at least 4% of the total fatty acids in the cell or in the extracted glycerolipid composition have a chain length that includes 8, 10, 12 or 14 carbon atoms.

“Axenic” means a culture of an organism that is not contaminated by other living organisms.

“Baked good” means a food item, typically found in a bakery, that is prepared by using an oven and usually contain a leavening agent. Baked goods include, but are not limited to brownies, cookies, pies, cakes and pastries.

“Bioreactor” and “fermentor” mean an enclosure or partial enclosure, such as a fermentation tank or vessel, in which cells are cultured typically in suspension.

“Bread” means a food item that contains flour, liquid, and usually a leavening agent. Breads are usually prepared by baking in an oven, although other methods of cooking are also acceptable. The leavening agent can be chemical or organic/biological in nature. Typically, the organic leavening agent is yeast. In the case where the leavening agent is chemical in nature (such as baking powder and/or baking soda), these food products are referred to as “quick breads”. Crackers and other cracker-like products are examples of breads that do not contain a leavening agent.

“Cellulosic material” means the products of digestion of cellulose, particularly glucose and xylose. Cellulose digestion typically produces additional compounds such as disaccharides, oligosaccharides, lignin, furfurals and other compounds. Sources of cellulosic material include, for example and without limitation, sugar cane bagasse, sugar beet pulp, corn stover, wood chips, sawdust, and switchgrass.

“Co-culture” and variants thereof such as “co-cultivate” and “co-ferment” mean that two or more types of cells are present in the same bioreactor under culture conditions. The two or more types of cells are, for purposes of the present invention, typically both microorganisms, typically both oleaginous yeasts, but may in some instances include one non-yeast cell type. Culture conditions suitable for co-culture include, in some instances, those that foster growth and/or propagation of the two or more cell types, and, in other instances, those that facilitate growth and/or proliferation of only one, or only a subset, of the two or more cells while maintaining cellular growth for the remainder.

“Cofactor” means a molecule, other than the substrate, required for an enzyme to carry out its enzymatic activity.

“Comminuted meat” means a meat product that is formed by reducing the size of the meat pieces, thereby promoting the extraction of salt soluble proteins that enable the comminuted meat to bind together. Comminution also results in a uniform distribution of fat, muscle and connective tissue. Non-limiting examples of comminuted meat include, meat patties, sausage, and hot dogs.

“Reformed meat” is related to comminuted meat and has an artifact of having the appearance of a cut, slice or portion of the meat that has been disrupted, and is formed by ‘tumbling’ chopped meat, with or without the addition of finely comminuted meat, whereby the soluble proteins of the chopped meat bind the small pieces together. Chicken nuggets are a non-limiting example of reformed meat.

“Conventional food product” means a composition intended for consumption, e.g., by a human, that lacks oleaginous yeast biomass or other oleaginous yeast components and includes ingredients ordinarily associated with the food product, particularly a vegetable oil, animal fat, and/or egg(s), together with other edible ingredients. Conventional food products include food products sold in shops and restaurants and those made in the home. Conventional food products are often made by following conventional recipes that specify inclusion of an oil or fat from a non-oleaginous yeast source and/or egg(s) together with other edible ingredient(s).

“Cooked product” means a food that has been heated, e.g., in an oven, for a period of time.

“Creamy salad dressing” means a salad dressing that is a stable dispersion with high viscosity and a slow pour-rate. Generally, creamy salad dressings are opaque.

“Cultivate,” “culture,” and “ferment”, and variants thereof, mean the intentional fostering of growth and/or propagation of one or more cells, typically oleaginous yeast, by use of culture conditions. Intended conditions exclude the growth and/or propagation of microorganisms in nature (without direct human intervention).

“Cytolysis” means the lysis of cells in a hypotonic environment. Cytolysis results from osmosis, or movement of water, to the inside of a cell to a state of hyperhydration, such that the cell cannot withstand the osmotic pressure of the water inside, and so bursts.

“Delipidated meal” means yeast biomass that has undergone an oil extraction process and so contains less oil, relative to the biomass prior to oil extraction. Cells in delipidated meal are predominantly lysed. Delipidated meal include yeast biomass that has been solvent (hexane) extracted.

“Dispersion” means a mixture in which fine particles of one substance are scattered throughout another substance. Although a dispersion can mean any particle that is scattered throughout the continuos phase of a different composition, the term dispersion as used herein refers to a fine solid of one substance that is scattered or dispersed throughout another substance, usually a liquid. An emulsion is a special type of dispersion to encompass a mixture of two or more immiscible liquids.

“Dry weight” and “dry cell weight” mean weight determined in the relative absence of water. For example, reference to oleaginous yeast biomass as comprising a specified percentage of a particular component by dry weight means that the percentage is calculated based on the weight of the biomass after substantially all water has been removed.

“Edible ingredient” means any substance or composition which is fit to be eaten. “Edible ingredients” include, without limitation, grains, fruits, vegetables, proteins, herbs, spices, carbohydrates, sugar and fats.

“Ingredient” includes, without limitation, preservatives, flavorants, food additives, food coloring, sugar substitutes and other ingredients found in various foods.

“Exogenously provided” means a molecule provided to a cell (including provided to the media of a cell in culture).

“Fat” means a lipid or mixture of lipids that is generally solid at ordinary room temperatures and pressures. “Fat” includes, without limitation, lard and butter.

“Finished food product” and “finished food ingredient” mean a food composition that is ready for packaging, use, or consumption. For example, a “finished food product” may have been cooked or the ingredients comprising the “finished food product” may have been mixed or otherwise integrated with one another. A “finished food ingredient” is typically used in combination with other ingredients to form a food product.

“Fixed carbon source” means molecule(s) containing carbon, typically organic molecules, that are present at ambient temperature and pressure in solid or liquid form.

“Food”, “food composition”, “food product” and “foodstuff” mean any composition intended to be or expected to be ingested by humans as a source of nutrition and/or calories. Food compositions are composed primarily of carbohydrates, fats, water and/or proteins and make up substantially all of a person's daily caloric intake. A “food composition” can have a weight minimum that is at least ten times the weight of a typical tablet or capsule (typical tablet/capsule weight ranges are from less than or equal to 100 mg up to 1500 mg). A “food composition” is not encapsulated or in tablet form.

“Glycerolipid profile” means the distribution of different carbon chain lengths and saturation levels of glycerolipids in a particular sample of biomass or oil. For example, a sample could have a glycerolipid profile in which approximately 60% of the glycerolipid is C18:1, 20%, 25%, 50% or 75% is C18:0, 15% is C16:0, and 5% is C14:0. When a carbon length is referenced generically, such as “C:18”, such reference can include any amount of saturation; for example, oleaginous yeast biomass that contains 20%, 25%, 50% or 75% (by weight/mass) lipid as C:18 can include C18:0, C18:1, C18:2, and the like, in equal or varying amounts, the sum of which constitute 20%, 25%, 50% or 75% of the biomass. Reference to percentages of a certain saturation type, such as “at least 50% monounsaturated in an 18:1 glycerolipid form” means the aliphatic side chains of the glycerolipids are at least 50% 18:1, but does not necessarily mean that at least 50% of the triglycerides are triolein (three 18:1 chains attached to a single glycerol backbone); such a profile can include glycerolipids with a mixture of 18:1 and other side chains, provided at least 50% of the total side chains are 18:1.

“Good manufacturing practice” and “GMP” mean those conditions established by regulations set forth at 21 C.F.R. 110 (for human food) and 111 (for dietary supplements), or comparable regulatory schemes established in locales outside the United States. The U.S. regulations are promulgated by the U.S. Food and Drug Administration under the authority of the Federal Food, Drug, and Cosmetic Act to regulate manufacturers, processors, and packagers of food products and dietary supplements for human consumption.

“Growth” means an increase in cell size, total cellular contents, and/or cell mass or weight of an individual cell, including increases in cell weight due to conversion of a fixed carbon source into intracellular oil.

“Heterotrophic cultivation” and variants thereof such as “heterotrophic culture” and “heterotrophic fermentation refer to the intentional fostering of growth (increases in cell size, cellular contents, and/or cellular activity) in the presence of a fixed carbon source. Heterotrophic cultivation is performed in the absence of light. Cultivation in the absence of light means cultivation of microbial cells in the complete absence or near complete absence of light where the cells do not derive a meaningful amount of their energy from light (ie: greater than 0.1%).

“Heterotrophic propagation” and variants thereof refer to the intentional fostering of propagation (increases in cell numbers via mitosis) in the presence of a fixed carbon source. Heterotrophic propagation is performed in the absence of light. Propagation in the absence of light means propagation of microbial cells in the complete absence or near complete absence of light where the cells do not derive a meaningful amount of their energy from light (ie: greater than 0.1%).

“Homogenate” means biomass that has been physically disrupted. Homogenization is a fluid mechanical process that involves the subdivision of particles into smaller and more uniform sizes, forming a dispersion that may be subjected to further processing. Homogenization is used in treatment of several foods and dairy products to improve stability, shelf-life, digestion, and taste.

“Increased lipid yield” means an increase in the lipid/oil productivity of a microbial culture that can achieved by, for example, increasing the dry weight of cells per liter of culture, increasing the percentage of cells that contain lipid, and/or increasing the overall amount of lipid per liter of culture volume per unit time.

“In situ” means “in place” or “in its original position”. For example, a culture may contain a first yeast cell type secreting a catalyst and a second microorganism cell type secreting a substrate, wherein the first and second cell types produce the components necessary for a particular chemical reaction to occur in situ in the co-culture without requiring further separation or processing of the materials.

“Lipid” means any of a class of molecules that are soluble in nonpolar solvents (such as ether and hexane) and relatively or completely insoluble in water. Lipid molecules have these properties, because they are largely composed of long hydrocarbon tails that are hydrophobic in nature. Examples of lipids include fatty acids (saturated and unsaturated); glycerides or glycerolipids (such as monoglycerides, diglycerides, triglycerides or neutral fats, and phosphoglycerides or glycerophospholipids); and nonglycerides (sphingolipids, tocopherols, tocotrienols, sterol lipids including cholesterol and steroid hormones, prenol lipids including terpenoids, fatty alcohols, waxes, and polyketides).

“Lysate” means a solution containing the contents of lysed cells.

“Lysis” means the breakage of the plasma membrane and optionally the cell wall of a microorganism sufficient to release at least some intracellular content, which is often achieved by mechanical or osmotic mechanisms that compromise its integrity.

“Lysing” means disrupting the cellular membrane and optionally the cell wall of a biological organism or cell sufficient to release at least some intracellular content.

“Micronized” means biomass that has been homogenized under high pressure (or an equivalent process) so that at least 50% of the particle size (median particle size) is no more 10 μm in their longest dimension or diameter of a sphere of equivalent volume. Typically, at least 50% to 90% or more of such particles are less than 5 μm in their longest dimension or diameter of a sphere of equivalent volume. In any case, the average particle size of micronized biomass is smaller than the intact oleaginous yeast cell. The particle sizes referred to are those resulting from the homogenization and are preferably measured as soon as practical after homogenization has occurred and before drying to avoid possible distortions caused by clumping of particles as may occur in the course of drying. Some techniques of measuring particle size, such as laser diffraction, detect the size of clumped particles rather individual particles and may show a larger apparent particle size (e.g., average particle size of 1-100 μm) after drying. Because the particles are typically approximately spherical in shape, the diameter of a sphere of equivalent volume and the longest dimension of a particle are approximately the same.

“Microorganism” and “microbe” mean any microscopic unicellular organism.

“Nutritional supplement” means a composition intended to supplement the diet by providing specific nutrients as opposed to bulk calories. A nutritional supplement may contain any one or more of the following ingredients: a vitamin, a mineral, an herb, an amino acid, an essential fatty acid, and other substances. Nutritional supplements are typically tableted or encapsulated. A single tableted or encapsulated nutritional supplement is typically ingested at a level no greater than 15 grams per day. Nutritional supplements can be provided in ready-to-mix sachets that can be mixed with food compositions, such as yogurt or a “smoothie”, to supplement the diet, and are typically ingested at a level of no more than 25 grams per day.

“Oleaginous yeast” means organisms from the Dikarya subkingdom of fungi that can naturally accumulate more than 20%, 25%, 50% or 75% of their dry cell weight as lipid. Oleaginous yeast includes organisms such as Yarrowia lipolytica, Rhodotorula glutinis, Cryptococcus curvatus and Lipomyces starkeyi.

“Oil” means any triacylglyceride (or triglyceride oil), produced by organisms, including microalgae, other plants, and/or animals. “Oil,” as distinguished from “fat”, refers, unless otherwise indicated, to lipids that are generally liquid at ordinary room temperatures and pressures. However, coconut oil is typically solid at room temp, as are some palm oils and palm kernel oils. For example, “oil” includes vegetable or seed oils derived from plants, including without limitation, an oil derived from soy, rapeseed, canola, palm, palm kernel, coconut, corn, olive, sunflower, cotton seed, cuphea, peanut, camelina sativa, mustard seed, cashew nut, oats, lupine, kenaf, calendula, hemp, coffee, linseed, hazelnut, euphorbia, pumpkin seed, coriander, camelina, sesame, safflower, rice, tung oil tree, cocoa, copra, pium poppy, castor beans, pecan, jojoba, jatropha, macadamia, Brazil nuts, and avocado, as well as combinations thereof.

“Osmotic shock” means the rupture of cells in a solution following a sudden reduction in osmotic pressure and can be used to induce the release of cellular components of cells into a solution.

“Pasteurization” means a process of heating which is intended to slow microbial growth in food products. Typically pasteurization is performed at a high temperature (but below boiling) for a short amount of time. As described herein, pasteurization can not only reduce the number of undesired microbes in food products, but can also inactivate certain enzymes present in the food product.

“Polysaccharide” and “glycan” means any carbohydrate made of monosaccharides joined together by glycosidic linkages. Cellulose is an example of a polysaccharide that makes up certain plant cell walls.

“Port” means an opening in a bioreactor that allows influx or efflux of materials such as gases, liquids, and cells; a port is usually connected to tubing.

“Predominantly encapsulated” means that more than 50% and typically more than 75% to 90% of a referenced component, e.g., yeast oil, is sequestered in a referenced container, which can include, e.g., a oleaginous yeast cell.

“Predominantly intact cells” and “predominantly intact biomass” mean a population of cells that comprise more than 50, and often more than 75, 90, and 98% intact cells. “Intact”, in this context, means that the physical continuity of the cellular membrane and/or cell wall enclosing the intracellular components of the cell has not been disrupted in any manner that would release the intracellular components of the cell to an extent that exceeds the permeability of the cellular membrane in culture.

“Predominantly lysed” means a population of cells in which more than 50%, and typically more than 75 to 90%, of the cells have been disrupted such that the intracellular components of the cell are no longer completely enclosed within the cell membrane.

“Proliferation” means a combination of both growth and propagation.

“Propagation” means an increase in cell number via mitosis or other cell division.

“Proximate analysis” means analysis of foodstuffs for fat, nitrogen/protein, crude fiber (cellulose and lignin as main components), moisture and ash. Soluble carbohydrate (total dietary fiber and free sugars) can be calculated by subtracting the total of the known values of the proximate analysis from 100 (carbohydrate by difference).

“Sonication” means disrupting biological materials, such as a cell, by sound wave energy.

“Species of furfural” means 2-furancarboxaldehyde and derivatives thereof that retain the same basic structural characteristics.

“Stover” means the dried stalks and leaves of a crop remaining after a grain has been harvested from that crop.

“Suitable for human consumption” means a composition can be consumed by humans as dietary intake without ill health effects and can provide significant caloric intake due to uptake of digested material in the gastrointestinal tract.

“Uncooked product” means a composition that has not been subjected to heating but may include one or more components previously subjected to heating.

“V/V” or “v/v”, in reference to proportions by volume, means the ratio of the volume of one substance in a composition to the volume of the composition. For example, reference to a composition that comprises 5% v/v yeast oil means that 5% of the composition's volume is composed of oleaginous yeast oil (e.g., such a composition having a volume of 100 mm³ would contain 5 mm³ of yeast oil), and the remainder of the volume of the composition (e.g., 95 mm³ in the example) is composed of other ingredients.

“W/W” or “w/w”, in reference to proportions by weight, means the ratio of the weight of one substance in a composition to the weight of the composition. For example, reference to a composition that comprises 5% w/w oleaginous yeast biomass means that 5% of the composition's weight is composed of oleaginous yeast biomass (e.g., such a composition having a weight of 100 mg would contain 5 mg of oleaginous yeast biomass) and the remainder of the weight of the composition (e.g., 95 mg in the example) is composed of other ingredients.

### II. METHODS FOR PREPARING OLEAGINOUS YEAST BIOMASS

The present invention provides oleaginous yeast biomass suitable for human consumption that is rich in nutrients, including lipid constituents, methods of combining the same with edible ingredients and food compositions containing the same. The invention arose in part from the discoveries that yeast biomass can be prepared with a high oil content and/or with excellent functionality, and the resulting biomass can be incorporated into food products in which the oil content of the biomass can substitute in whole or in part for oils, fats and/or proteins present in conventional food products. Yeast oil, which can comprise predominantly monounsaturated triglyceride oil, provides health benefits compared with saturated, hydrogenated (trans fats) and polyunsaturated fats often found in conventional food products. Yeast oil can also be used a healthy stable cooking oil free of trans fats.

This section first reviews the types of oleaginous yeast suitable for use in the methods of the invention (part A), the culture conditions for generating yeast biomass (part B), then the concentration steps that are used to prepare the biomass for further processing (part C), and concludes with a description of the chemical composition of the biomass prepared in accordance with the methods of the invention (part D).

A. Oleaginous Yeast for Use in the Methods of the Invention

A variety of species of yeast that produce suitable oils and/or lipids can be used in accordance with the methods of the present invention, although yeast that naturally produce high (20%, 25%, 50% or 75% of dry cell weight or higher) levels of suitable oils and/or lipids are preferred. Considerations affecting the selection of yeast for use in the invention include, in addition to production of suitable oils or lipids for production of food products: (1) high lipid content as a percentage of cell weight; (2) ease of growth; (3) ease of propagation; (4) ease of biomass processing; and (5) glycerolipid profile.

In some embodiments, the cell wall of the oleaginous yeast must be disrupted during food processing to release the active components or for digestion, and, in these embodiments, strains of oleaginous yeast with cell walls susceptible to digestion in the gastrointestinal tract of an animal, e.g., a human or other monogastrics, are preferred, especially if the oleaginous yeast biomass is to be used in uncooked food products. Digestibility can be evaluated using a standard pepsin digestibility assay.

In particular embodiments, the oleaginous yeast comprise cells that are at least 20%, 25%, 50% or 75% or more triglyceride oil by dry weight. In other embodiments, the oleaginous yeast contains at least 25-35% or more triglyceride oil by dry weight. Generally, in these embodiments, the more oil contained in the oleaginous yeast, the more nutritious the biomass, so oleaginous yeast that can be cultured to contain at least 40%, at least 50%, or at least 60% or more triglyceride oil by dry weight are especially preferred. Not all types of lipids are desirable for use in foods and/or nutraceuticals, as they may have an undesirable taste or unpleasant odor, as well as exhibit poor stability or provide a poor mouthfeel, and these considerations also influence the selection of oleaginous yeast for use in the methods of the invention.

Suitable species of oleaginous yeast for use in the invention include, but are not limited to Candida apicola, Candida sp., Cryptococcus curvatus, Cryptococcus terricolus, Debaromyces hansenii, Endomycopsis vernalis, Geotrichum carabidarum, Geotrichum cucujoidarum, Geotrichum histeridarum, Geotrichum silvicola, Geotrichum vulgare, Hyphopichia burtonii, Lipomyces lipofer, Lypomyces orentalis, Lipomyces starkeyi, Lipomyces tetrasporous, Pichia mexicana, Rodosporidium sphaerocarpum, Rhodosporidium toruloides Rhodotorula aurantiaca, Rhodotorula dairenensis, Rhodotorula diffluens, Rhodotorula glutinus, Rhodotorula glutinis var. glutinis, Rhodotorula gracilis, Rhodotorula graminis Rhodotorula minuta, Rhodotorula mucilaginosa, Rhodotorula mucilaginosa var. mucilaginosa, Rhodotorula terpenoidalis, Rhodotorula toruloides, Sporobolomyces alborubescens, Starmerella bombicola, Torulaspora delbruekii, Torulaspora pretoriensis, Trichosporon behrend, Trichosporon brassicae, Trichosporon domesticum, Trichosporon laibachii, Trichosporon loubieri, Trichosporon loubieri var. loubieri, Trichosporon montevideense, Trichosporon pullulans, Trichosporon sp., Wickerhamomyces Canadensis, Yarrowia lipolytica, and Zygoascus meyerae.

Species of oleaginous yeast for use in the invention can be identified by comparison of certain target regions of their genome with those same regions of species identified herein; preferred species are those that exhibit identity or at least a very high level of homology with the species identified herein. For examples, identification of a specific oleaginous yeast species or strain can be achieved through amplification and sequencing of genomic DNA using primers and methodology using appropriate regions of the genome, for example using the methods described in Kurtzman and Robnett, Antonie van Leeuwenhoek 73(4): 331-371 (1998), Identification and phylogeny of ascomycetous yeasts from analysis of nuclear large subunit (26S) ribosomal DNA partial sequences. Well established methods of phylogenetic analysis, such as amplification and sequencing of nuclear 18S and 26S and internal transcribed spacer (ITS) regions of ribosomal RNA genes and other conserved regions can be used by those skilled in the art to identify species of oleaginous yeasts suitable for use in the methods disclosed herein.

Thus, genomic DNA comparison can be used to identify suitable species of oleaginous yeast to be used in the present invention. Regions of conserved genomic DNA, such as, but not limited to conserved genomic sequences between 3′ regions of fungal 18S and 5′ regions of fungal 26S rRNA genes can be amplified from yeast species that may be, for example, taxonomically related to the preferred oleaginous yeasts used in the present invention and compared to the corresponding regions of those preferred species. Species that exhibit a high level of similarity are then selected for use in the methods of the invention. Example 6 describes genomic sequencing of conserved 3′ regions of fungal 18S and 5′ regions of fungal 26S rRNA for 48 strains of oleaginous yeasts and a taxonomic comparison of all 48 strains. Genotyping of a food composition and/or of oleaginous yeast biomass before it is combined with other ingredients to formulate a food composition is also a reliable method for determining if yeast biomass is from more than a single strain/species of yeast.

For sequence comparison to determine percent nucleotide or amino acid identity, typically one sequence acts as a reference sequence, to which test sequences are compared. In applying a sequence comparison algorithm, test and reference sequences are input into a computer, subsequence coordinates are designated, if necessary, and sequence algorithm program parameters are designated. The sequence comparison algorithm then calculates the percent sequence identity for the test sequence(s) relative to the reference sequence, based on the designated program parameters. Optimal alignment of sequences for comparison can be conducted, e.g., by the local homology algorithm of Smith & Waterman, Adv. Appl. Math. 2:482 (1981), by the homology alignment algorithm of Needleman & Wunsch, J. Mol. Biol. 48:443 (1970), by the search for similarity method of Pearson & Lipman, Proc. Nat'l. Acad. Sci. USA 85:2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by visual inspection (see generally Ausubel et al., supra). Another example algorithm that is suitable for determining percent sequence identity and sequence similarity is the BLAST algorithm, which is described in Altschul et al., J. Mol. Biol. 215:403-410 (1990). Software for performing BLAST analyses is publicly available through the National Center for Biotechnology Information (at the web address www.ncbi.nlm.nih.gov).

The methods and compositions of the invention are useful for generating raw materials for food from a large class or eukaryotic, oleaginous yeast. Exemplary species cultivated and described herein include numerous species from the Dikarya subkingdom of fungi such as Rhodosporidium toruloides (Eukaryota; Fungi/Metazoa group; Fungi; Dikarya; Basidiomycota; Pucciniomycotina; Microbotryomycetes; Sporidiobolales; Rhodosporidium); Rhodotorula glutinis (Eukaryota; Fungi/Metazoa group; Fungi; Dikarya; Basidiomycota; Pucciniomycotina; Microbotryomycetes; Sporidiobolales; mitosporic Sporidiobolales; Rhodotorula); Lipomyces tetrasporus (Eukaryota; Fungi/Metazoa group; Fungi; Dikarya; Ascomycota; Saccharomyceta; Saccharomycotina; Saccharomycetes; Saccharomycetales; Lipomycetaceae; Lipomyces); Cryptococcus curvatus (Eukaryota; Fungi/Metazoa group; Fungi; Dikarya; Basidiomycota; Agaricomycotina; Tremellomycetes; Tremellales; mitosporic Tremellales; Cryptococcus); Trichosporon domesticum (Eukaryota; Fungi/Metazoa group; Fungi; Dikarya; Basidiomycota; Agaricomycotina; Tremellomycetes; Tremellales; mitosporic Tremellales; Trichosporon); Yarrowia lipolytica (Eukaryota; Fungi/Metazoa group; Fungi; Dikarya; Ascomycota; Saccharomyceta; Saccharomycotina; Saccharomycetes; Saccharomycetales; Dipodascaceae; Yarrowia); Sporobolomyces alborubescens (Eukaryota; Fungi/Metazoa group; Fungi; Dikarya; Basidiomycota; Pucciniomycotina; Microbotryomycetes; Sporidiobolales; mitosporic Sporidiobolales; Sporobolomyces); Geotrichum vulgare (Eukaryota; Fungi/Metazoa group; Fungi; Dikarya; Ascomycota; Saccharomyceta; Saccharomycotina; Saccharomycetes; Saccharomycetales; Dipodascaceae; mitosporic Dipodascaceae; Geotrichum): and Torulaspora delbrueckii (Eukaryota; Fungi/Metazoa group; Fungi; Dikarya; Ascomycota; Saccharomyceta; Saccharomycotina; Saccharomycetes; Saccharomycetales; Saccharomycetaceae; Torulaspora). Within Dikarya, the invention includes use of organisms from all sub-domains of Dikarya (Ascomycota and Basidiomycota) and taxonomic sub-classifications within Ascomycota and Basidiomycota.

B. Media and Culture Conditions for Oleaginous Yeast

Oleaginous yeast are cultured in liquid media to propage biomass in accordance with the methods of the invention. In the methods of the invention, oleaginous yeast species are grown in a medium containing a fixed carbon source and/or fixed nitrogen source in the absence of light (heterotrophic growth). Heterotrophic growth of oleaginous yeast usually occurs in an aerobic environment. For example, heterotrophic growth for extended periods of time such as 10 to 15 or more days under limited nitrogen conditions can result in accumulation of light lipid/oil content in cells.

Oleaginous yeast culture media typically contains components such as a fixed carbon source (discussed below), a fixed nitrogen source (such as protein, soybean meal, yeast extract, cornsteep liquor, ammonia (pure or in salt form), nitrate, or nitrate salt), trace elements, optionally a buffer for pH maintenance, and phosphate (a source of phosphorous; other phosphate salts can be used).

In a particular example, a medium suitable for culturing oleaginous yeast strains is YPD medium. This medium is suitable for axenic cultures, and a 1 L volume of the medium (pH ˜6.8) can be prepared by addition of 10 g bacto-yeast, 20 g bacto-peptone and 40 g glucose into distilled water. For 1.5% agar medium, 15 g of agar can be added to 1 L of the solution. The solution is covered and autoclaved, and then stored at a refrigerated temperature prior to use. Other methods for the growth and propagation of oleaginous yeast strains to generate high lipid levels as a percentage of dry weight have been described (see for example Li et al., Enzyme and Microbial Technology (2007) 41:312-317 (demonstrating the culturing Rhodosporidium toruloides to 67.5% w/w lipid using fed batch fermentation)). High lipid/oil content in oleaginous yeast can typically be generated by increasing the length of fermentation while providing an excess of carbon source under nitrogen limitation.

Solid and liquid growth media are generally available from a wide variety of sources, and instructions for the preparation of particular media that is suitable for a wide variety of strains of oleaginous yeast can be found, for example, online at http://www.dsmz.de/microorganisms/medium/pdf/DSMZ_Medium186.pdf

Other suitable media for use with the methods of the invention can be readily identified by consulting the URL identified above, or by consulting other organizations that maintain cultures of oleaginous yeast such as Fungal Culture Collections of The World Austrian Center of Biological Resources and Applied Mycology (http://www.biotec.boku.ac.at/acbr.html); The Biomedical Fungi and Yeasts Collection (http://bccm.belspo.be/about/ihem.php); Czech Collection of Microorganisms (http://sci.muni.cz/ccm/index.html); Institut Pasteur (http://www.pasteur.fr/ip/easysite/go/03b-000011-08h/); German Collection of Microorganisms and Cell Cultures (http://www.dsmz.de/); Mychoteca Univesitatis Taurinenesis (http://web086.unito.it/cgi-bin/bioveg/documenti.pl/Show?_id=b522); Riken Bioresource Center Japan Collection of Microorganisms (http://www.jcm.riken.jp/JCM/announce.shtml); The National Collection of Yeast Cultures (http://www.ncyc.co.uk/); ATCC (http://www.atcc.org/); Phaff Yeast Culture Collection (http://www.phaffcollection.org/).

Oleaginous yeast useful in accordance with the methods of the present invention are found in various locations and environments throughout the world. As a consequence of their isolation from other species and their resulting evolutionary divergence, the particular growth medium for optimal growth and generation of oil and/or lipid and/or protein from any particular species of microbe can be difficult or impossible to predict, but those of skill in the art can readily find appropriate media by routine testing in view of the disclosure herein. In some cases, certain strains of microorganisms may be unable to grow on a particular growth medium because of the presence of some inhibitory component or the absence of some essential nutritional requirement required by the particular strain of microorganism. The examples below provide exemplary methods of culturing various species of oleaginous yeast to accumulate high levels of lipid as a percentage of dry cell weight.

The fixed carbon source is a key component of the medium. Suitable fixed carbon sources for purposes of the present invention, include, for example, glucose, fructose, sucrose, galactose, xylose, mannose, rhamnose, arabinose, N-acetylglucosamine, glycerol, floridoside, glucuronic acid, and/or acetate. Other carbon sources for culturing oleaginous yeast in accordance with the present invention include mixtures, such as mixtures of glycerol and glucose, mixtures of glucose and xylose, mixtures of fructose and glucose, and mixtures of sucrose and depolymerized sugar beet pulp. Other carbon sources suitable for use in culturing oleaginous yeast include, black liquor, corn starch, depolymerized cellulosic material (derived from, for example, corn stover, sugar beet pulp, and switchgrass, for example), lactose, milk whey, molasses, potato, rice, sorghum, sucrose, sugar beet, sugar cane, and wheat. The one or more carbon source(s) can be supplied at a concentration of at least about 50 μM, at least about 100 μM, at least about 500 μM, at least about 5 mM, at least about 50 mM, and at least about 500 mM.

Thus, in various embodiments, the fixed carbon energy source used in the growth medium comprises glycerol and/or 5- and/or 6-carbon sugars, such as glucose, fructose, and/or xylose, which can be derived from sucrose and/or cellulosic material, including depolymerized cellulosic material. Multiple species of yeast and multiple strains within a species can be grown in the presence of sucrose, depolymerized cellulosic material, and glycerol, as described in US Patent Application Publication Nos. 20090035842, 20090011480, 20090148918, respectively, and see also, PCT Patent Application Publication No. 2008/151149, each of which is incorporated herein by reference.

Thus, in one embodiment of the present invention, microorganisms are cultured using depolymerized cellulosic biomass as a feedstock. As opposed to other feedstocks, such as corn starch or sucrose from sugar cane or sugar beets, cellulosic biomass (depolymerized or otherwise) is not suitable for human consumption and could potentially be available at low cost, which makes it especially advantageous for purposes of the present invention.

Oleaginous yeasts can proliferate on depolymerized cellulosic material. Cellulosic materials generally include cellulose at 40-60% dry weight; hemicellulose at 20-40% dry weight; and lignin at 10-30% dry weight. Suitable cellulosic materials include residues from herbaceous and woody energy crops, as well as agricultural crops, i.e., the plant parts, primarily stalks and leaves, not removed from the fields with the primary food or fiber product. Examples include agricultural wastes such as sugarcane bagasse, rice hulls, corn fiber (including stalks, leaves, husks, and cobs), wheat straw, rice straw, sugar beet pulp, citrus pulp, citrus peels; forestry wastes such as hardwood and softwood thinnings, and hardwood and softwood residues from timber operations; wood wastes such as saw mill wastes (wood chips, sawdust) and pulp mill waste; urban wastes such as paper fractions of municipal solid waste, urban wood waste and urban green waste such as municipal grass clippings; and wood construction waste. Additional cellulosics include dedicated cellulosic crops such as switchgrass, hybrid poplar wood, and miscanthus, fiber cane, and fiber sorghum. Five-carbon sugars that are produced from such materials include xylose. Example 5 describes Rhodotorula glutinis successfully being cultivated under heterotrophic conditions using cellulosic-derived sugars from cornstover and sugar beet pulp.

Some microbes are able to process cellulosic material and directly utilize cellulosic materials as a carbon source. However, cellulosic material typically needs to be treated to increase the accessible surface area or for the cellulose to be first broken down as a preparation for microbial utilization as a carbon source. Ways of preparing or pretreating cellulosic material for enzyme digestion are well known in the art. The methods are divided into two main categories: (1) breaking apart the cellulosic material into smaller particles in order to increase the accessible surface area; and (2) chemically treating the cellulosic material to create a useable substrate for enzyme digestion.

Methods for increasing the accessible surface area include steam explosion, which involves the use of steam at high temperatures to break apart cellulosic materials. Because of the high temperature requirement of this process, some of the sugars in the cellulosic material may be lost, thus reducing the available carbon source for enzyme digestion (see for example, Chahal, D. S. et al., Proceedings of the 2^{nd} World Congress of Chemical Engineering; (1981) and Kaar et al., Biomass and Bioenergy (1998) 14(3): 277-87). Ammonia explosion allows for explosion of cellulosic material at a lower temperature, but is more costly to perform, and the ammonia might interfere with subsequent enzyme digestion processes (see for example, Dale, B. E. et al., Biotechnology and Bioengineering (1982); 12: 31-43). Another explosion technique involves the use of supercritical carbon dioxide explosion in order to break the cellulosic material into smaller fragments (see for example, Zheng et al., Biotechnology Letters (1995); 17(8): 845-850).

Methods for chemically treating the cellulosic material to create useable substrates for enzyme digestion are also known in the art. U.S. Pat. No. 7,413,882 describes the use of genetically engineered microbes that secrete beta-glucosidase into the fermentation broth and treating cellulosic material with the fermentation broth to enhance the hydrolysis of cellulosic material into glucose. Cellulosic material can also be treated with strong acids and bases to aid subsequent enzyme digestion. U.S. Pat. No. 3,617,431 describes the use of alkaline digestion to break down cellulosic materials.

Some species of oleaginous yeast can proliferate on media containing combinations of xylose and glucose, such as depolymerized cellulosic material. Thus, certain oleaginous yeasts can both utilize an otherwise inedible feedstock, such as cellulosic material (or a pre-treated cellulosic material) or glycerol, as a carbon source and produce edible oils. In some cases, lignocellulosic degradation products can have an inhibitory effect on oleaginous yeast growth. One study reported that acetic acid, formic acid, furfural and vanillin (common lignocellulosic degradation products) were strong inhibitors of growth for some species of oleaginous yeasts. (Chen et al., Appl. Biochem. Biotech. (2009) 159: 591-604). In certain embodiments, minimizing lignocellulosic degradation products may be advantageous for the growth of certain oleaginous yeast species/strains.

The use of cellulosic material as a carbon source allows conversion of inedible cellulose and glycerol, which are normally not part of the human food chain (as opposed to corn glucose and sucrose from sugar cane and sugar beet) into high nutrition, edible oils, which can provide nutrients and calories as part of the daily human diet. Thus, the invention provides methods for turning inedible feedstock into high nutrition edible oils, food products, and food compositions.

High lipid biomass from oleaginous yeast is an advantageous material for inclusion in food products compared to low lipid biomass, because it allows for the addition of less yeast biomass to incorporate the same amount of lipid into a food composition. This is advantageous, because healthy oils from high lipid oleaginous yeast can be added to food products without altering other attributes such as color and texture compared with low lipid biomass. The lipid-rich biomass provided by the methods of the invention typically has at least 25% lipid by dry cell weight.

Process conditions can be adjusted to increase the percentage weight of cells that is lipid. For example, in certain embodiments, oleaginous yeast is cultured in the presence of a limiting concentration of one or more nutrients, such as, for example, nitrogen, phosphate, and certain metallic ions, while providing an excess of a fixed carbon source, such as glucose. Nitrogen limitation tends to increase microbial lipid yield over microbial lipid yield in a culture in which nitrogen is provided in excess. In particular embodiments, the increase in lipid yield is at least about 10%, 50%, 100%, 200%, or 500%. The microbe can be cultured in the presence of a limiting amount of a nutrient for a portion of the total culture period or for the entire period. In some embodiments, the nutrient concentration is cycled between a limiting concentration and a non-limiting concentration at least twice during the total culture period.

In a steady growth state, the cells accumulate oil but do not undergo cell division. In one embodiment of the invention, the growth state is maintained by continuing to provide all components of the original growth media to the cells with the exception of a fixed nitrogen source. Cultivating oleaginous yeast by feeding all nutrients originally provided to the cells except a fixed nitrogen source, such as through feeding the cells for an extended period of time, results in a higher percentage of lipid by dry cell weight.

In other embodiments, high lipid biomass is generated by feeding a fixed carbon source to the cells after all fixed nitrogen has been consumed for extended periods of time, such as at least one or two weeks. In some embodiments, cells are allowed to accumulate oil in the presence of a fixed carbon source and in the absence of a fixed nitrogen source for over 20 days. Oleaginous yeast grown using conditions described herein or otherwise known in the art can comprise at least about 20%, 25%, 50% or 75% lipid by dry weight, and often comprise 35%, 45%, 55%, 65%, and even 75% or more lipid by dry weight. Percentage of dry cell weight as lipid in microbial lipid production can therefore be improved by holding cells in a growth state in which they consume carbon and accumulate oil but do not undergo cell division.

Conditions in which nitrogen is in excess tends to increase microbial protein yield over microbial protein yield in a culture in which nitrogen is not provided in excess. For maximal protein production, the microbe is preferably cultured in the presence of excess nitrogen for the total culture period. Suitable nitrogen sources for oleaginous yeast may come from organic nitrogen sources and/or inorganic nitrogen sources.

Non-limiting examples of organic nitrogen sources are yeast extract, peptone, corn steep liquor and corn steep powder. Non-limiting examples of preferred inorganic nitrogen sources include, for example, and without limitation, (NH₄)₂SO₄ and NH₄OH. In one embodiment, the culture media for carrying out the invention contains only inorganic nitrogen sources. In another embodiment, the culture media for carrying out the invention contains only organic nitrogen sources. In yet another embodiment, the culture media for carrying out the invention contains a mixture of organic and inorganic nitrogen sources.

An example of a medium formulation used to grow oleaginous yeast include: 7 g/L KH₂PO₄; 2 g/L Na₂HPO₄; 1.5 g/L MgSO₄.7H₂O; 1.5 g/L yeast extract; 0.2 g/L CaCl₂.6H₂O; 0.1 g/L FeCl₃.6H₂O; 0.001 g/L biotin and 0.001 g/L ZnSO₄.7H₂O with a pH level adjusted to 5.5 with HCL and with 12 g/L glucose and 30 g/L NH₄Cl as a nitrogen source. Another medium that is used to grow oleaginous yeast include: 20 g/L glucose; 0.5 g/L yeast extract; 5 g/L (NH₄)₂SO₄; and 1 g/L KH₂PO₄; 0.5 g/L MgSO₄.7H₂O. One medium formulation for the growth of oleaginous in a fermentor consists of: 30 g/L glucose; 20 g/L xylose; 2 g/L (NH₄)₂SO₄; 1 g/L KH₂PO₄; and 0.5 g/L MgSO₄.7H₂O.

In the methods of the invention, a bioreactor or fermentor is used to culture oleaginous yeast cells through the various phases of their physiological cycle. As an example, an inoculum of lipid-producing oleaginous yeast cells is introduced into the medium; there is a lag period (lag phase) before the cells begin to propagate. Following the lag period, the propagation rate increases steadily and enters the log, or exponential, phase. The exponential phase is in turn followed by a slowing of propagation due to decreases in nutrients such as nitrogen, increases in toxic substances, and quorum sensing mechanisms. After this slowing, propagation stops, and the cells enter a stationary phase or steady growth state, depending on the particular environment provided to the cells. For obtaining protein rich biomass, the culture is typically harvested during or shortly after then end of the exponential phase. For obtaining lipid rich biomass, the culture is typically harvested well after then end of the exponential phase, which may be terminated early by allowing nitrogen or another key nutrient (other than carbon) to become depleted, forcing the cells to convert the carbon sources, present in excess, to lipid. Culture condition parameters can be manipulated to optimize total oil production, the combination of lipid species produced, and/or production of a specific oil.

To produce biomass for use in food, oleaginous yeast are preferably fermented in large quantities in liquid, such as in suspension cultures as an example. Bioreactors such as steel fermentors (5000 liter, 10,000 liter, 40,000 liter, and higher are used in various embodiments of the invention) can accommodate very large culture volumes. Bioreactors also typically allow for the control of culture conditions such as temperature, pH, oxygen tension, and carbon dioxide levels. For example, bioreactors are typically configurable, for example, using ports attached to tubing, to allow gaseous components, like oxygen or nitrogen, to be bubbled through a liquid culture.

Bioreactors can be configured to flow culture media though the bioreactor throughout the time period during which the oleaginous yeast reproduce and increase in number. In some embodiments, for example, media can be infused into the bioreactor after inoculation but before the cells reach a desired density. In other instances, a bioreactor is filled with culture media at the beginning of a culture, and no more culture media is infused after the culture is inoculated. In other words, the oleaginous yeast biomass is cultured in an aqueous medium for a period of time during which the yeast reproduce and increase in number; however, quantities of aqueous culture medium are not flowed through the bioreactor throughout the time period. Thus in some embodiments, aqueous culture medium is not flowed through the bioreactor after inoculation.

Bioreactors equipped with devices such as spinning blades and impellers, rocking mechanisms, stir bars, means for pressurized gas infusion can be used to subject oleaginous yeast cultures to mixing. Mixing may be continuous or intermittent.

As briefly mentioned above, bioreactors are often equipped with various ports that, for example, allow the gas content of the culture of oleaginous yeast to be manipulated. To illustrate, part of the volume of a bioreactor can be gas rather than liquid, and the gas inlets of the bioreactor to allow pumping of gases into the bioreactor. Gases that can be beneficially pumped into a bioreactor include air, air/CO₂ mixtures, noble gases, such as argon, and other gases. Bioreactors are typically equipped to enable the user to control the rate of entry of a gas into the bioreactor. As noted above, increasing gas flow into a bioreactor can be used to increase mixing of the culture.

Increased gas flow affects the turbidity of the culture as well. Turbulence can be achieved by placing a gas entry port below the level of the aqueous culture media so that gas entering the bioreactor bubbles to the surface of the culture. One or more gas exit ports allow gas to escape, thereby preventing pressure buildup in the bioreactor. Preferably a gas exit port leads to a “one-way” valve that prevents contaminating microorganisms from entering the bioreactor.

The specific examples of bioreactors, culture conditions, and heterotrophic growth and propagation methods described herein can be combined in any suitable manner to improve efficiencies of microbial growth and lipid and/or protein production.

C. Concentration of Oleaginous Yeast After Fermentation

Oleaginous yeast cultures generated according to the methods described above yield oleaginous yeast biomass in fermentation media. To prepare the biomass for use as a food composition, the biomass is concentrated, or harvested, from the fermentation medium. At the point of harvesting the oleaginous yeast biomass from the fermentation medium, the biomass comprises predominantly intact cells suspended in an aqueous culture medium. To concentrate the biomass, a dewatering step is performed, optionally followed by a washing step and a second dewatering step. Dewatering or concentrating refers to the separation of the biomass from fermentation broth or other liquid medium and so is solid-liquid separation. Thus, during dewatering, the culture medium is removed from the biomass (for example, by draining the fermentation broth through a filter that retains the biomass), or the biomass is otherwise removed from the culture medium. Common processes for dewatering include centrifugation, filtration, and the use of mechanical pressure. These processes can be used individually or in any combination.

Centrifugation involves the use of centrifugal force to separate mixtures. During centrifugation, the more dense components of the mixture migrate away from the axis of the centrifuge, while the less dense components of the mixture migrate towards the axis. By increasing the effective gravitational force (i.e., by increasing the centrifugation speed), more dense material, such as solids, separate from the less dense material, such as liquids, and so separate out according to density. Centrifugation of biomass and broth or other aqueous solution forms a concentrated paste comprising the oleaginous yeast cells. Centrifugation does not remove significant amounts of intracellular water. In fact, after centrifugation, there may still be a substantial amount of surface or free moisture in the biomass (e.g., upwards of 70%), so centrifugation is not considered to be a drying step.

Filtration can also be used for dewatering. One example of filtration that is suitable for the present invention is tangential flow filtration (TFF), also known as cross-flow filtration. Tangential flow filtration is a separation technique that uses membrane systems and flow force to separate solids from liquids. For an illustrative suitable filtration method, see Geresh, Carb. Polym. 50; 183-189 (2002), which describes the use of a MaxCell A/G Technologies 0.45 uM hollow fiber filter. Also see, for example, Millipore Pellicon® devices, used with 100 kD, 300 kD, 1000 kD (catalog number P2C01MC01), 0.1 uM (catalog number P2VVPPV01), 0.22 uM (catalog number P2GVPPV01), and 0.45 uM membranes (catalog number P2HVMPV01). The retentate preferably does not pass through the filter at a significant level, and the product in the retentate preferably does not adhere to the filter material. TFF can also be performed using hollow fiber filtration systems. Filters with a pore size of at least about 0.1 micrometer, for example about 0.12, 0.14, 0.16, 0.18, 0.2, 0.22, 0.45, or at least about 0.65 micrometers, are suitable. Preferred pore sizes of TFF allow solutes and debris in the fermentation broth to flow through, but not microbial cells.

Dewatering can also be effected with mechanical pressure directly applied to the biomass to separate the liquid fermentation broth from the microbial biomass sufficient to dewater the biomass but not to cause predominant lysis of cells. Mechanical pressure to dewater microbial biomass can be applied using, for example, a belt filter press. A belt filter press is a dewatering device that applies mechanical pressure to a slurry (e.g., microbial biomass taken directly from the fermentor or bioreactor) that is passed between the two tensioned belts through a serpentine of decreasing diameter rolls. The belt filter press can actually be divided into three zones: the gravity zone, where free draining water/liquid is drained by gravity through a porous belt; a wedge zone, where the solids are prepared for pressure application; and a pressure zone, where adjustable pressure is applied to the gravity drained solids.

After concentration, oleaginous yeast biomass can be processed, as described hereinbelow, to produce a multifunctional food ingredient.

D. Chemical Composition of Oleaginous Yeast

The oleaginous yeast biomass generated by the culture methods described herein comprises oil and/or protein as well as other constituents generated by the yeast cells or incorporated by the yeast cells from the culture medium during fermentation.

Oleaginous yeast biomass with a high percentage of oil/lipid accumulation by dry weight has been generated using different methods of culture, including methods known in the art. Oleaginous yeasts with a higher percentage of accumulated oil/lipid is useful in accordance with the present invention. Candida 107 was shown to be able to accumulate up to 40% lipid wt/wt under nitrogen limiting conditions (Gill et al., Appl and Environ Microbiology (1977) pp. 231-239). Li et al. demonstrated the production of Rhodosporidium toruloids 44 in fed-batch cultures to a lipid content of 48% w/w (Li et al., Enzyme and Microbial Technology (2007) 41:312-317. Yarrowia lipolytica has been show to be able to produce between 0.44-0.54 g of lipid per gram of biomass when using animal fat (stearin) as a carbon source (Panpanikolaou et al., Appl Microbiol Biotechnol (2002) 58:308-312.

### III. PROCESSING OLEAGINOUS YEAST INTO FINISHED FOOD INGREDIENTS

The concentrated oleaginous yeast biomass produced in accordance with the methods of the invention is itself a finished food ingredient and may be used in foodstuffs without further, or with only minimal, modification. For example, the cake (after concentration) can be vacuum-paced or frozen. Alternatively, the biomass may be dried via methods such as drum drying, flash drying, spray drying, and lyophilization, a “freeze-drying” process, in which the biomass is frozen in a freeze-drying chamber to which a vacuum is applied. The application of a vacuum to the freeze-drying chamber results in sublimation (primary drying) and desorption (secondary drying) of the water from the biomass. The present invention also provides a variety of oleaginous yeast derived finished food ingredients with enhanced properties resulting from processing methods of the invention that can be applied to the concentrated oleaginous yeast biomass.

Drying the oleaginous yeast biomass, either predominantly intact or in a predominantly lysed form, is advantageous to facilitate further processing or for use of the biomass in the methods and compositions described herein. Drying refers to the removal of intracellular and free or surface moisture/water from predominantly intact biomass or the removal of surface water from a dispersion of the biomass that has been lysed. Different textures and other properties can be conferred on food products depending on whether the oleaginous yeast biomass is dried, and if so, the drying methods. Drying the biomass generated from the cultured oleaginous yeast described herein removes water that may be an undesirable component of the finished food products or food ingredients. In some case, drying the biomass may improve yields during an oleaginous yeast oil extraction process.

In one embodiment, the concentrated oleaginous yeast is dried and the biomass is predominantly intact, with few (if any) lysed cells, as described in Part A of this section. In another embodiment, the concentrated yeast biomass is lysed to form a dispersion and this dispersion of predominantly lysed yeast biomass is then spray or flash dried to produce yeast flour, as described in part B of this section. In another embodiment, oil is extracted from the concentrated oleaginous yeast biomass to form yeast oil, as described in part C of this section.

A. Dried Whole Cell Oleaginous Yeast

The oleaginous yeast of the invention can be dried after concentration as predominately intact biomass. The method of drying the biomass will impact the texture of the resulting dried oleaginous yeast biomass. Depending on the specific needs of any subsequent food application/formulation that will be incorporating the oleaginous yeast biomass, the choice of the drying method may impact the success of the food application/formulation.

In one method, the concentrated oleaginous yeast biomass is dried as a flake and is predominantly intact biomass. Yeast flake of the invention is prepared from concentrated oleaginous yeast biomass that is applied as a film to the surface of a rolling, heated drum. The dried solids are then scraped off with a knife or blade, resulting in small flakes. U.S. Pat. No. 6,607,900 describes drying microalgal biomass using a drum dryer without a prior centrifugation (concentration) step, and such a process may be used in accordance with the methods of the invention.

Because the biomass may be exposed to high heat during the drying process, it may be advantageous to add an antioxidant to the biomass prior to drying. The addition of an antioxidant will not only protect the biomass during drying, but also extend the shelf-life of the dried oleaginous yeast biomass when stored. In a preferred embodiment, an antioxidant is added to the oleaginous yeast biomass prior to subsequent processing such as drying or homogenization. Antioxidants that are suitable for use are discussed in detail below.

Additionally, if there is significant time between the production of the concentrated oleaginous yeast biomass and subsequent processing steps, it may be advantageous to pasteurize the biomass prior to drying. Free fatty acids from lipases may form if there is significant time between producing and drying the biomass. Pasteurization of the biomass inactivates these lipases and prevents the formation of a “soapy” flavor in the resulting dried biomass product. Thus, in one embodiment, the invention provides pasteurized oleaginous yeast biomass. In another embodiment, the pasteurized oleaginous yeast biomass is in the form of a flake.

In other method, the concentrated oleaginous yeast biomass is predominantly intact biomass and is dried as a powder. Oleaginous yeast powder of the invention is prepared from concentrated, predominantly intact, oleaginous yeast biomass using a pneumatic or spray dryer (see for example U.S. Pat. No. 6,372,460). In a spray dryer, material in a liquid suspension is sprayed in a fine droplet dispersion into a current of heated air. The entrained material is rapidly dried and forms a dry powder. In some cases, a pulse combustion dryer can also be used to achieve a powdery texture in the final dried material. In other cases, a combination of spray drying followed by the use of a fluid bed dryer is used to achieve the optimal conditions for dried oleaginous yeast biomass (see, for example, U.S. Pat. No. 6,255,505). As an alternative, pneumatic dryers can also be used in the production of oleaginous yeast powder. Pneumatic dryers draw or entrain the material that is to be dried in a stream of hot air. While the material is entrained in the hot air, the moisture is rapidly removed. The dried material is then separated from the moist air and the moist air is then recirculated for further drying of material.

B. Dried Lysed Oleaginous Yeast

The oleaginous yeast of the invention can be further processed after concentration in order to lyse the oleaginous yeast biomass before drying. The oleaginous yeast biomass can be mechanically lysed or homogenized in a liquid to form a dispersion. The dispersion is then spray dried or flash dried into a powder form (or dried using another pneumatic drying system). This method of drying lysed biomass into a powder forms an oleaginous yeast flour that can be used in a variety of food application/formulations.

The production of oleaginous yeast flour requires that the cells be lysed to release their oil and that the cell wall and intracellular components be micronized or at least reduced in particle size. In some embodiments, the oleaginous yeast biomass is lysed using a high pressure homogenizer to form a dispersion. Following homogenization, the resulting oil, water, and micronized particles are in a stable dispersion such that the oil does not separate from the dispersion prior to drying. For example, a pressure disrupter can be used to pump the concentrated yeast biomass (which may or may not need to be diluted depending on what the optimal percent solids is required for the specific homogenizing machinery) through a restricted orifice valve to lyse the cells. High pressure (more than 1000 bar) is applied, followed by an instant expansion through an exiting nozzle. Cell disruption is accomplished by three different mechanisms: impingement on the valve, high liquid shear in the orifice, and sudden pressure drop upon discharge, causing an explosion of the cell. The method releases intracellular molecules. Alternatively, a Niro (Niro Soavi GEA) homogenizer (or any other high pressure homogenizer) can be used to process cells to particles predominantly 0.2 to 5 microns in length/diameter. Processing of oleaginous yeast biomass under high pressure (at least 1000 bar) typically lyses over 90% of the cells and reduces particle size to less than 5 microns.

Alternatively, a ball mill or bead mill can be used. In a ball mill, cells are agitated in suspension with small abrasive particles, such as beads. Cells break because of shear forces, grinding between beads, and collisions with beads. The beads disrupt the cells to release cellular contents. In one embodiment, oleaginous yeast biomass is disrupted and formed into a stable dispersion using a Dyno-mill ECM Ultra (CB Mills) ball mill. A suitable ball mill, including specifics of ball size and blade is described in U.S. Pat. No. 5,330,913. Cells can also be disrupted by shear forces, such as with the use of blending (such as with a high speed or Waring blender as non-limiting examples), the french press, or even centrifugation in the case of weak cell walls, to disrupt cells.

The immediate product of homogenization or high pressure lysing is a dispersion of oleaginous yeast particles smaller in size than the original cells that is suspended in oil and water (along with other intracellular components such as proteins and carbohydrates). Additional water or liquid may be contributed by aqueous media containing the cells before homogenization. The particles are preferably in the form of a micronized dispersion. If left to stand, some of the smaller particles may coalesce. However, an even dispersion of small particles can be preserved by seeding with a microcrystalline stabilizer, such as microcrystalline cellulose.

The stable dispersion of lysed oleaginous yeast cells can be used as a food ingredient for incorporation into food formulation/applications. In one embodiment, the oleaginous yeast cells are lysed and in the form of a stable dispersion with a liquid. This dispersion can be dried into a flour and later reconstituted to form another stable dispersion for ease of transport or formulation.

To form the oleaginous yeast flour, the dispersion is dried (such as through spray or flash drying), removing water and leaving a dry powder-like material containing cellular debris and oil. Although the oil content of the flour (i.e., disrupted cells as a powder-like material) can be at least 10, 25, 40, or 50% or more by weight of the dry flour, the flour can have a dry, rather than greasy feel and appearance (e.g., lacking visible oil) and can also flow freely when shaken. Various flow agents (including silica-derived products such as precipitated silica, fumed silica, calcium silicate, and sodium aluminum silicates) can also be added. Application of these materials to high fat, hygroscopic or sticky powders prevents caking or clumping during and after drying, and in package, promotes free-flow of dry powders. This not only reduces sticking, but also reduces build up and oxidation of materials on dryer surfaces. All are approved for food use at FDA designated maximum levels. After drying, the water or moisture content of the powder is typically less than 10%, 5% 3% or 1% by weight. Other dryers such as pneumatic dryers or pulse combustion dryers can also be used to produce oleaginous yeast flour.

The oil content of the flour can vary depending on the percent oil of the oleaginous yeast biomass. Oleaginous yeast flour can be produced from yeast biomass of varying oil content. In certain embodiments, the oleaginous yeast flour is produced from yeast biomass of the same oil content. In other embodiments, the oleaginous yeast flour is produced from yeast biomass of different oil content. In the latter case, oleaginous yeast biomass of varying oil content can be combined and then the homogenization or lysis step performed. In other embodiments, oleaginous yeast flour of varying oil content is produced first and then blended together in various proportions in order to achieve an oleaginous flour product that contains the final desired oil content. In a further embodiment, oleaginous yeast biomass of different lipid profiles can be combined together and then homogenized to produce oleaginous yeast flour. In another embodiment, oleaginous yeast flour of different lipid profiles are produced first and then blended together in various proportions in order to achieve an oleaginous yeast flour product that contains the final desired lipid profile.

The oleaginous yeast of the invention is useful for a wide range of food preparations. Because of the oil content, fiber content and the micronized particles, oleaginous yeast flour is a multifunctional food ingredient. Oleaginous yeast flour can be used in baked goods, quick breads, yeast dough products, egg products, dressings, sauces, nutritional beverages, milk, pasta and gluten free products. Gluten-free products can be made using oleaginous yeast flour and another gluten-free product such as amaranth flour, arrow root flour, buckwheat flour, rice flour, chickpea flour, cornmeal, maize flour, millet flour, potato flour, potato starch flour, quinoa flour, sorghum flour, soy flour, bean flour, legume flour, tapioca (cassava) flour, teff flour, artichoke flour, almond flour, acorn flour, coconut flour, chestnut flour, corn flour and taro flour. Oleaginous yeast flour, in combination with other gluten-free ingredients is useful in making gluten-free food products such as baked goods (cakes, cookie, brownies and cake-like products (e.g., muffins)), breads, cereal, crackers and pastas.

Oleaginous yeast flour can be used in baked goods in place of convention fat sources (e.g., oil, butter or margarine) and eggs. Baked goods and gluten free products have superior moisture content and a crumb structure that is indistinguishable from conventional baked goods made with butter and eggs. Because of the superior moisture content, these baked goods retain their original texture longer than conventional baked goods that are produced without oleaginous yeast flour.

Oleaginous yeast flour can also act as a fat extender with used in smoothies, sauces, or dressings. The composition of oleaginous yeast flour is unique in its ability to convey organoleptic qualities and mouth-feel comparable to a food product with a higher fat content. This also demonstrates the ability of the oleaginous yeast flour to act as texture modifier. Dressings, sauces and beverages made with oleaginous yeast flour have a rheology and opacity that is close to conventional higher fat recipes although these food products contains about half the fat/oil levels. Oleaginous yeast flour is also a superior emulsifier and is suitable in use in food preparation that requires thickness, opacity and viscosity, such as, sauces, dressings and soups. Additionally the lipid profile found in some of the oleaginous yeast flour of the inventions described herein does not contain trans-fat and have a higher level of healthy, unsaturated fats as compared to butter or margarine (or other animal fats). Thus, products made with oleaginous yeast flour can have a lower fat content (with healthier fats) without sacrificing the mouthfeel and organoleptic qualities of the same food product that is made using a conventional recipe using a conventional fat source.

Oleaginous yeast flour can also be added to powdered or liquid eggs, which are typically served in a food service setting. The combination of a powdered egg product and oleaginous yeast flour is itself a powder, which can be combined with an edible liquid or other edible ingredient, typically followed by cooking to form a food product. In some embodiments, the oleaginous yeast flour can be combined with a liquid product that will then be sprayed dried to form a powdered food ingredient (e.g., powdered eggs, powdered sauce mix, powdered soup mix, etc). In such instances, it is advantageous to combine the oleaginous yeast flour after homogenization, but before drying so that is a slurry or dispersion, with the liquid product and then spray dry the combination, forming the powdered food ingredient. This co-drying process will increase the homogeneity of the powdered food ingredient as compared to mixing the dried forms of the two components together. The addition of oleaginous yeast flour may improve the appearance, texture and mouthfeel of powdered and liquid eggs and also may extend improved appearance, texture and mouthfeel over time, even when the prepared eggs are held on a steam table.

Oleaginous yeast flour can be used to formulate reconstituted food products by combining oleaginous yeast flour with one or more edible ingredients and liquid, such as water. The reconstituted food product can be a beverage, dressing (such as salad dressing), sauce (such as a cheese sauce), or an intermediate such as a dough that can then be baked. In some embodiments, the reconstituted food product is then subjected to shear forces such as pressure disruption or homogenization. This has the effect of reducing particle size of the oleaginous yeast flour in the finished product because the high oil content of the flour can cause agglomeration during the reconstitution process.

In some cases, the oleaginous yeast flour is prepared from concentrated oleaginous yeast biomass that has been mechanically lysed and homogenized and the homogenate spray or flash dried into a powder form (or dried using another pneumatic drying system). The production of yeast flour requires that cells be lysed to release their oil and that cell wall and intracellular components be micronized or at least reduced in particle size. The average size of particles measured immediately after homogenation or as soon is practical thereafter is preferably no more than 10, no more than 25, or no more than 100 μm. In some embodiments, the average particle size is 1-10, 1-15, 10-100 or 1-40 μm. In some embodiments, the average particle size is greater than 10 μm and up to 100 μm. In some embodiments, the average particle size is 0.1-100 μm.

In some cases, the average particle size of the yeast flour is less than 10 μm. Varying the homogenization conditions can produce different particle sizes. The skilled artisan will recognize that the homogenization conditions can be varied to yield different particle sizes.

The individual cells comprising the biomass (yeast biomass particles) or the yeast flour particles agglomerate to varying degrees. In one embodiment, the agglomerated yeast flour particles or the agglomerated yeast biomass particles have particle sizes of less than about 1,000 μm, less than 750 μm, less than 500 μm, less than 250 μm, or less than 100 μm.

C. Oleaginous Yeast Oil

In one aspect, the present invention is directed to a method of preparing oleaginous yeast oil by harvesting yeast oil from an oleaginous yeast biomass comprising at least 20%, 25%, 50% or 75% oil by dry weight under GMP conditions. In some cases, the oleaginous yeast biomass comprises a mixture of at least two distinct species of yeast. In some cases, the at least two distinct species of oleaginous yeast have been separately cultured. In at least one embodiment, at least two of the distinct species of oleaginous yeast have different glycerolipid profiles (fatty acid profiles). In some cases, all of the at least two distinct species of oleaginous yeast contain at least 20%, 25%, 50% or 75% oil by dry weight. In some embodiments, the oleaginous yeast biomass comprises only one strain of oleaginous yeast.

In one aspect, the present invention is directed to a method of making food composition comprising oleaginous yeast oil obtained from oleaginous yeast cells containing at least 10, or at least 20%, 25%, 50% or 75% glycerolipids by dry weight with one or more other edible ingredients to form the food composition. In some cases, the method further comprises preparing the oleaginous yeast oil under GMP conditions.

Oleaginous yeast oil can be separated from lysed biomass for use in food product (among other applications). The oleaginous yeast biomass remaining after oil extraction is referred to as delipidated meal. Delipidated meal contains less oil by dry weight or volume than the oleaginous yeast biomass contained before extraction. Typically 50-90% of oil is extracted so that delipidated meal contains, for example, 10-50% of the oil content of biomass before extraction. However, the biomass still has a high nutrient value in content of protein and other constituents discussed above. Thus, the delipidated meal can be used in animal feed or in human food applications.

Oleaginous yeast containing lipids can be lysed to produce a lysate. The step of lysing a microorganism (also referred to as cell lysis) can be achieved by any convenient means, including heat-induced lysis, adding a base, adding an acid, using enzymes such as proteases and polysaccharide degradation enzymes such as amylases, using ultrasound, mechanical pressure-based lysis, and lysis using osmotic shock. Each of these methods for lysing a microorganism can be used as a single method or in combination simultaneously or sequentially. The extent of cell disruption can be observed by microscopic analysis. Using one or more of the methods above, typically more than 70% cell breakage is observed. Preferably, cell breakage is more than 80%, more preferably more than 90% and most preferred about 100%.

Lipids and oils generated by the oleaginous yeast in accordance with the present invention can be recovered by extraction. In some cases, extraction can be performed using an organic solvent or an oil, or can be performed using a solventless-extraction procedure.

For organic solvent extraction of the oleaginous yeast oil, the preferred organic solvent is hexane. Typically, the organic solvent is added directly to the lysate without prior separation of the lysate components. In one embodiment, the lysate generated by one or more of the methods described above is contacted with an organic solvent for a period of time sufficient to allow the lipid components to form a solution with the organic solvent. In some cases, the solution can then be further refined to recover specific desired lipid components. The mixture can then be filtered and the hexane removed by, for example, rotoevaporation. Hexane extraction methods are well known in the art. See, e.g., Frenz et al., Enzyme Microb. Technol., 11:717 (1989).

In some cases, oleaginous yeast (microbial) oils can be extracted using liquefaction (see for example Sawayama et al., Biomass and Bioenergy 17:33-39 (1999) and Inoue et al., Biomass Bioenergy 6(4):269-274 (1993)); oil liquefaction (see for example Minowa et al., Fuel 74(12):1735-1738 (1995)); or supercritical CO₂ extraction (see for example Mendes et al., Inorganica Chimica Acta 356:328-334 (2003)). Microbial oil extracted via supercritical CO2 extraction would contain all of the sterols and carotenoids from the microbial biomass and naturally do not contain phospholipids as a function of the extraction process. The residual from the processes essentially comprises delipidated microbial biomass devoid of oil, but still retains the protein and carbohydrates of the pre-extraction microbial biomass. Thus, the residual delipidated microbial biomass is suitable feedstock for the production of microbial protein concentrate/isolate and also as a source of dietary fiber.

Oil extraction includes the addition of an oil directly to a lysate without prior separation of the lysate components. After addition of the oil, the lysate separates either of its own accord or as a result of centrifugation or the like into different layers. The layers can include in order of decreasing density: a pellet of heavy solids, an aqueous phase, an emulsion phase, and an oil phase. The emulsion phase is an emulsion of lipids and aqueous phase. Depending on the percentage of oil added with respect to the lysate (w/w or v/v), the force of centrifugation if any, volume of aqueous media and other factors, either or both of the emulsion and oil phases can be present. Incubation or treatment of the cell lysate or the emulsion phase with the oil is performed for a time sufficient to allow the lipid produced by the microorganism to become solubilized in the oil to form a heterogeneous mixture.

In various embodiments, the oil used in the extraction process is selected from the group consisting of oil from soy, rapeseed, canola, palm, palm kernel, coconut, corn, waste vegetable oil, Chinese tallow, olive, sunflower, cotton seed, chicken fat, beef tallow, porcine tallow, microalgae, macroalgae, Cuphea, flax, peanut, choice white grease (lard), Camelina sativa mustard seedcashew nut, oats, lupine, kenaf, calendula, hemp, coffee, linseed, hazelnut, euphorbia, pumpkin seed, coriander, camellia, sesame, safflower, rice, tung oil tree, cocoa, copra, pium poppy, castor beans, pecan, jojoba, jatropha, macadamia, Brazil nuts, and avocado. The amount of oil added to the lysate is typically greater than 5% (measured by v/v and/or w/w) of the lysate with which the oil is being combined. Thus, a preferred v/v or w/w of the oil is greater than 5%, 10%, 20%, 25%, 50% or 75%, 25%, 50%, 70%, 90%, or at least 95% of the cell lysate.

Lipids can also be extracted from a lysate via a solventless extraction procedure without substantial or any use of organic solvents or oils by cooling the lysate. Sonication can also be used, particularly if the temperature is between room temperature and 65° C. Such a lysate on centrifugation or settling can be separated into layers, one of which is an aqueous:lipid layer. Other layers can include a solid pellet, an aqueous layer, and a lipid layer. Lipid can be extracted from the emulsion layer by freeze thawing or otherwise cooling the emulsion. In such methods, it is not necessary to add any organic solvent or oil. If any solvent or oil is added, it can be below 5% v/v or w/w of the lysate.

Lipids can also be extracted from the oleaginous biomass through mechanical methods including the use of expeller press. In this process, biomass is forced through a screw-type device at high pressure, lysing the cells and causing the intracellular lipid to be released and separated from the protein and fiber (and other components) in the cells. Separating lipids from other components using an expeller press is a common method used on oil seed such as soybean, canola and cottonseed. Example 4 describes extracting lipids from Rhodotorula glutinis biomass using an expeller press.

### IV. COMBINING OLEAGINOUS YEAST BIOMASS OR MATERIALS DERIVED THEREFROM WITH OTHER FOOD INGREDIENTS

In one aspect, the present invention is directed to a food composition comprising at least 0.1% w/w oleaginous yeast biomass and one or more other edible ingredients, wherein the oleaginous yeast biomass comprises at least 20%, 25%, 50% or 75% oil by dry weight, optionally wherein at least 90% of the oil is glycerolipids.

In some cases, the oleaginous yeast biomass comprises predominantly intact cells. In some embodiments, the food composition comprises oil which is predominantly or completely encapsulated inside cells of the biomass. In some cases the food composition comprises predominantly intact oleaginous yeast cells. In other cases, the biomass comprises predominantly lysed cells. As discussed above, such lysed cells can be provided as a dispersion or a flour.

In some cases, the oleaginous yeast biomass of the food composition contains components that have antioxidant qualities. The strong antioxidant qualities can be attributed to the multiple antioxidants present in the oleaginous yeast biomass, which include, but are not limited to carotenoids, essential minerals such as zinc, copper, magnesium, calcium, and manganese. In other cases, oleaginous yeast biomass can contain B vitamins. B vitamins have been shown to play an important role in maintaining a healthy metabolism, immune system, nervous system and promote cell division in red blood cells that help prevent anemia. Other yeast products (that do not contain an appreciable amount of oil/glycerolipids), such as Marmite and Vegemite are rich sources of B vitamins.

In some cases, the choice of the strain of oleaginous yeast for use in the food composition is based in part on the glycerolipid (fatty acid) profile of the strain of oleaginous yeast. In some cases, the glycerolipid profile of an oleaginous yeast species/strain can include a high amount or proportion of unsaturated fatty acids. In some cases, specific fatty acids (and oleaginous yeast strains that produce high levels of this specific fatty acid) may be desirable because of health benefits. As a non-limiting example, C16:1 or palmitoleic acid has been shown to be a possible signaling molecule for the body to stop accumulating fat/adipose tissue. Palmitoleic acid has also been shown to be important in cholesterol regulation and may be important in the prevention of diabetes. Another example is C18:1 or oleic acid, which is a mono-unsaturated omega 9 fatty acid. It is thought that oleic acid may be responsible for the blood pressure reducing effects of olive oil. Thus, it may be advantageous to choose or include oleaginous yeast biomass/oil that contains high amount of a desired fatty acid.

In some embodiments of the food composition, the oleaginous yeast biomass is derived from oleaginous yeast cultured and dried under good manufacturing practice (GMP) conditions. In some cases, the oleaginous yeast biomass is combined with one or more other edible ingredients, including without limitation, grain, fruit, vegetable, protein, lipid, herb and/or spice ingredients. In some cases, the food composition is a salad dressing, egg product, baked good, bread, bar, pasta, sauce, soup drink, beverage, frozen dessert, butter or spread. In particular embodiments, the food composition is not a pill or powder. In some cases, the food composition in accordance with the present invention weighs at least 50 g, or at least 100 g.

Biomass can be combined with one or more other edible ingredients to make a food product. The biomass can be from a single oleaginous yeast source (e.g., strain) or oleaginous yeast biomass from multiple sources (e.g., different strains). The biomass can also be from a single oleaginous yeast species, but with different composition profile. The combination of different stains of oleaginous yeast or the same strain of oleaginous yeast, but with different lipid profiles, can be performed by a food manufacturer to make a finished product for retail sale or food service use. Alternatively, a manufacturer can sell oleaginous yeast biomass as a product, and a consumer can incorporate the oleaginous yeast biomass into a food product, for example, by modification of a conventional recipe. In either case, the oleaginous yeast biomass is typically used to replace all or part of the oil, fat, eggs, or the like used in many conventional food products.

In one aspect, the present invention is directed to methods of combining oleaginous yeast biomass and/or materials derived therefrom, as described above, with at least one other finished food ingredient, as described below, to form a food composition or foodstuff. In various embodiments, the food composition formed by the methods of the invention comprises an egg product (powdered or liquid), a pasta product, a dressing product, a mayonnaise product, a cake product, a bread product, an energy bar, a milk product, a juice product, a spread, or a smoothie. In some cases, the food composition is not a pill or powder. In various embodiments, the food composition weighs at least 10 g, at least 25 g, at least 50 g, at least 100 g, at least 250 g, or at least 500 g or more. In some embodiments, the food composition formed by the combination of oleaginous yeast biomass and/or product derived therefrom is an uncooked product. In other cases, the food composition is a cooked product.

In other cases, the food composition is a cooked product. In some cases, the food composition contains less than 25% oil or fat by weight excluding oil contributed by the oleaginous yeast biomass. Fat, in the form of saturated triglycerides (TAGs) or trans fats, is made when hydrogenating vegetable oils, as is practiced when making spreads such as margarines. In some cases, the food composition contains less than 10% oil or fat by weight excluding oil contributed by the biomass. In at least one embodiment, the food composition is free of oil or fat excluding oil contributed by the biomass. In some cases, the food composition is free of oil other than oil contributed by the biomass. In some cases, the food composition is free of egg or egg yolks.

In one aspect, the present invention is directed to a method of making a food composition in which the fat or oil in a conventional food product is fully or partially substituted with oleaginous yeast biomass containing at least 20%, 25%, 50% or 75% by weight oil. In one embodiment, the method comprises determining an amount of the oleaginous yeast biomass for substitution using the proportion of oleaginous yeast oil in the biomass and the amount of oil or fat in the conventional food product, and combining the oleaginous yeast biomass with at least one other edible ingredient and less than the amount of oil or fat contained in the conventional food product to form a food composition. In some cases, the amount of oleaginous yeast biomass combined with the at least one other ingredient is 1-4 times the mass or volume of oil and/or fat in the conventional food product.

In some embodiments, the method described above further includes providing a recipe for a conventional food product containing the at least one other edible ingredient combined with an oil or fat, and combining 1-4 times the mass or volume of the oleaginous yeast biomass with the at least one other edible ingredient as the mass or volume of fat or oil in the conventional food product. In some cases, the method further includes preparing the oleaginous yeast biomass under GMP conditions.

As described above, oleaginous yeast biomass can be substituted for other components that would otherwise be conventionally included in a food product. In some embodiments, the food composition contains less than 50%, less than 40%, or less than 30% oil or fat by weight excluding oleaginous yeast oil contributed by the biomass or from oleaginous yeast sources. In some cases, the food composition contains less than 25%, less than 20%, 25%, 50% or 75%, less than 15%, less than 10%, or less than 5% oil or fat by weight excluding oleaginous yeast oil contributed by the biomass or from oleaginous yeast sources. In at least one embodiment, the food composition is free of oil or fat excluding oleaginous yeast oil contributed by the biomass or from oleaginous yeast sources. In some cases, the food composition is free of eggs, butter, or other fats/oils or at least one other ingredient that would ordinarily be included in a comparable conventional food product. Some food products are free of dairy products (e.g., butter, cream and/or cheese).

The amount of oleaginous yeast biomass used to prepare a food composition depends on the amount of non-yeast oil, fat, eggs, or the like to be replaced in a conventional food product and the percentage of oil in the oleaginous yeast biomass. Thus, in at least one embodiment, the methods of the invention include determining an amount of the oleaginous yeast biomass to combine with at least one other edible ingredient from a proportion of oil in the biomass and a proportion of oil and/or fat that is ordinarily combined with the at least one other edible ingredient in a conventional food product. For example, if the oleaginous yeast biomass is 50% w/w glycerolipid (oleaginous yeast oil), and complete replacement of oil or fat in a conventional recipe is desired, then the oil can for example be replaced in a 2:1 ratio. The ratio can be measured by mass, but for practical purposes, it is often easier to measure volume using a measuring cup or spoon, and the replacement can be by volume. In a general case, the volume or mass of oil or fat to be replaced is replaced by (100/100-X) volume or mass of oleaginous yeast biomass, where X is the percentage of in the biomass. In general, oil and fats to be replaced in conventional recipes can be replaced in total by oleaginous yeast biomass, although total replacement is not necessary and any desired proportion of oil and/or fats can be retained and the remainder replaced according to taste and nutritional needs.

Because the oleaginous yeast biomass contains proteins and phospholipids, which function as emulsifiers, items such as eggs can be replaced in total or in part with oleaginous yeast biomass. If an egg is replaced in total with biomass, it is sometimes desirable or necessary to augment the emulsifying properties in the food composition with an additional emulsifying agent(s) and/or add additional water or other liquid(s) to compensate for the loss of these components that would otherwise be provided by the egg. Because an egg is not all fat, the amount of biomass used to replace an egg may be less than that used to replace pure oil or fat. An average egg weighs about 58 g and comprises about 11.2% fat. Thus, about 13 g of oleaginous yeast biomass comprising 50% yeast oil by weight can be used to replace the total fat portion of an egg in total. Replacing all or part of the eggs in a food product has the additional benefit of reducing cholesterol.

For simplicity, substitution ratios can also be provided in terms of mass or volume of oil, fat and/or eggs replaced with mass or volume of biomass. In some methods, the mass or volume of oil, fat and/or eggs in a conventional recipe is replaced with 5-150%, 25-100% or 25-75% of the mass or volume of oil, fat and/or eggs. The replacement ratio depends on factors such as the food product, desired nutritional profile of the food product, overall texture and appearance of the food product, and oil content of the biomass.

In cooked foods, the determination of percentages (i.e., weight or volume) can be made before or after cooking. The percentage of oleaginous yeast biomass can increase during the cooking process because of loss of liquids. Because some oleaginous yeast biomass cells may lyse in the course of the cooking process, it can be difficult to measure the content of oleaginous yeast biomass directly in a cooked product. However, the content can be determined indirectly from the mass or volume of biomass that went into the raw product as a percentage of the weight or volume of the finished product (on a biomass dry solids basis), as well as by methods of analyzing components that are unique to the oleaginous yeast biomass such as genomic sequences or compounds that are delivered solely by the oleaginous yeast biomass, such as certain carotenoids.

In some cases, it may be desirable to combine oleaginous yeast biomass with the at least one other edible ingredient in an amount that exceeds the proportional amount of oil, fat, eggs, or the like that is present in a conventional food product. For example, one may replace the mass or volume of oil and/or fat in a conventional food product with 1, 2, 3, 4, or more times that amount of oleaginous yeast biomass. Some embodiments of the methods of the invention include providing a recipe for a conventional food product containing the at least one other edible ingredient combined with an oil or fat, and combining 1-4 times the mass or volume of oleaginous yeast biomass with the at least one other edible ingredient as the mass or volume of fat or oil in the conventional food product.

Oleaginous yeast biomass (predominantly intact or homogenized or micronized) and/or yeast oil are combined with at least one other edible ingredient to form a food product. In some food products, the oleaginous yeast biomass and/or yeast oil is combined with 1-20, 2-10, or 4-8 other edible ingredients. The edible ingredients can be selected from all the major food groups, including without limitation, fruits, vegetables, legumes, meats, fish, grains (e.g., wheat, rice, oats, cornmeal, barley), herbs, spices, water, vegetable broth, juice, wine, and vinegar. In some food compositions, at least 2, 3, 4, or 5 food groups are represented as well as the oleaginous yeast biomass or oleaginous yeast oil.

Oils, fats, eggs and the like can also be combined into food compositions, but, as has been discussed above, are usually present in reduced amounts (e.g., less than 50%, 25%, or 10% of the mass or volume of oil, fat or eggs compared with conventional food products. Some food products of the invention are free of oil other than that provided by oleaginous yeast biomass and/or yeast oil. Some food products are free of fats other than that provided by oleaginous yeast biomass or yeast oil. Some food products are free of both oil and fats other than that provided by oleaginous yeast biomass or yeast oil. Some food products are free of eggs. In some embodiments, the oils produced by the oleaginous yeast can be tailored by culture conditions or strain selection to comprise a particular fatty acid component(s) or levels.

As well as using oleaginous yeast biomass as an oil, fat or egg replacement in otherwise conventional foods, oleaginous yeast biomass can be used as a supplement in foods that do not normally contain oil, such as a smoothie. The combination of oil with products that are mainly carbohydrate can have benefits associated with the oil, and from the combination of oil and carbohydrate by reducing the glycemic index of the carbohydrate. The provision of oil encapsulated in biomass is advantageous in protecting the oil from oxidation and can also improve the taste and texture of the smoothie.

Oil extracted from oleaginous yeast biomass can be used in the same way as the biomass itself, that is, as a replacement for oil, fat, eggs, or the like in conventional recipes. The oil can be used to replace conventional oil and/or fat on about a 1:1 weight/weight or volume/volume basis. The oil can also be incorporated into dressings, sauces, soups, margarines, creamers, shortenings and the like. The oil is particularly useful for food products in which combination of the oil with other food ingredients is needed to give a desired taste, texture and/or appearance. The content of oil by weight or volume in food products can be at least 5, 10, 25, 40 or 50%.

In at least one embodiment, oil extracted from oleaginous yeast biomass can also be used as a cooking oil by food manufacturers, restaurants and/or consumers. In such cases, yeast oil can replace conventional cooking oils such as safflower oil, canola oil, olive oil, grape seed oil, corn oil, sunflower oil, coconut oil, palm oil, or any other conventionally used cooking oil. The oil obtained from oleaginous yeast biomass as with other types of oil can be subjected to further refinement to increase its suitability for cooking (e.g., increased smoke point). Oil can be neutralized with caustic soda to remove free fatty acids. The free fatty acids form a removable soap stock. The color of oil can be removed by bleaching with chemicals such as carbon black and bleaching earth. The bleaching earth and chemicals can be separated from the oil by filtration. Oil can also be deodorized by treating with steam.

Both predominantly intact and lysed oleaginous yeast biomass also supply high quality protein (balanced amino acid composition), carbohydrates, fiber and other nutrients as discussed above. Foods incorporating any of these products can be made in vegan or vegetarian form.

In one aspect, the present invention is directed to a food ingredient composition comprising at least 0.5% w/w oleaginous yeast biomass containing at least 20%, 25%, 50% or 75% yeast oil by dry weight and at least one other edible ingredient, in which the food ingredient can be converted into a reconstituted food product by addition of a liquid to the food ingredient composition. In one embodiment, the liquid is water.

Homogenized or micronized lipid rich biomass is particularly advantageous in liquid, and/or emulsified food products (water in oil and oil in water emulsions), such as sauces, soups, drinks, salad dressings, butters, spreads and the like in which oil contributed by the biomass forms an emulsion with other liquids. Products that benefit from improved rheology, such as dressings, sauces and spreads. Using predominantly lysed oleaginous yeast biomass (such as yeast flour) an emulsion with desired texture (e.g., mouth-feel) and appearance (e.g., opacity) can form at a lower oil content (by weight or volume of overall product) than is the case with conventional products employing conventional oils, thus can be used as a fat extender. Such is useful for low-calorie (i.e., diet) products. Purified yeast oil is also advantageous for such liquid and/or emulsified products. Both homogenized or micronized lipid rich biomass and purified yeast oil combine well with other edible ingredients in baked goods achieving similar or better taste, appearance and texture to otherwise similar products made with conventional oils, fats and/or eggs but with improved nutritional profile (e.g., higher content of monosaturated oil, and/or higher content or quality of protein, and/or higher content of fiber and/or other nutrients).

Both predominantly intact biomass and oleaginous yeast flour can be used as a bulking agent. Bulking agents can be used, for example, to augment the amount of a more expensive food (e.g., meat helper and the like) or in simulated or imitation foods, such as vegetarian meat substitutes. Simulated or imitation foods differ from natural foods in that the flavor and bulk are usually provided by different sources. For example, flavors of natural foods, such as meat, can be imparted into a bulking agent holding the flavor. Oleaginous yeast biomass can be used as a bulking agent in such foods. Oleaginous yeast biomass can also be added to comminuted meat products such as bologna, sausage and the like. Because of lipid rich content of the oleaginous yeast biomass, leaner meat sources can be used (such as from turkey or chicken) in place of pork or beef, thus providing a source of unsaturated fat, but making the meat product richer tasting.

Oleaginous yeast biomass (predominantly intact and/or homogenized or micronized) and/or yeast oil can be incorporated into virtually any food composition. Some examples include baked goods, such as cakes, brownies, yellow cake, bread including brioche, cookies including sugar cookies, biscuits, and pies. Other examples include products often provided in dried form, such as pastas or powdered dressing, dried creamers, comminuted meats and meat substitutes. Re-hydrated foods, such as scrambled eggs made from dried powdered eggs, may also have improved texture and nutritional profile. Other examples include liquid food products, such as sauces, soups, dressings (ready to eat), creamers, milk drinks, juice drinks, smoothies, creamers. Other liquid food products include nutritional beverages that serve as a meal replacement or “milk”. Other food products include butters or cheeses and the like including shortening, margarine/spreads, nut butters, and cheese products, such as nacho sauce. Other food products include energy bars, chocolate confections-lecithin replacement, meal replacement bars, granola bar-type products. Another type of food product is batters and coatings.

Oleaginous yeast biomass can also be useful in increasing the satiety index of a food product (e.g., a meal-replacement drink or smoothie) relative to an otherwise similar conventional product made without the oleaginous yeast biomass. The satiety index is a measure of the extent to which the same number of calories of different foods to satisfy appetite. Such an index can be measured by feeding a food being tested and measuring appetite for other foods at a fixed interval thereafter. The smaller the appetite for other foods, the higher the satiety index. Values of satiety index can be expressed on a scale in which white bread is assigned a value of 100. Foods with a higher satiety index are useful for dieting. Although not dependent on an understanding of mechanism, oleaginous yeast biomass is believed to increase the satiety index of a food by increasing the protein and/or fiber content of the food for a given amount of calories.

Oleaginous yeast biomass (predominantly intact and homogenized or micronized) and/or yeast oil can also be manufactured into nutritional or dietary supplements. For example, yeast oil can be encapsulated into digestible capsules in a manner similar to fish oil. Such capsules can be packaged in a bottle and taken on a daily basis (e.g., 1-4 capsules or tablets per day). A capsule can contain a unit dose of oleaginous yeast biomass or yeast oil. Likewise, biomass can be optionally compressed with pharmaceutical or other excipients into tablets. The tablets can be packaged, for example, in a bottle or blister pack, and taken daily at a dose of, e.g., 1-4 tablets per day. In some cases, the tablet or other dosage formulation comprises a unit dose of oleaginous yeast biomass or yeast oil. Manufacturing of capsule and tablet products and other supplements is preferably performed under GMP conditions appropriate for nutritional supplements as codified at 21 C.F.R. 111, or comparable regulations established by foreign jurisdictions. The oleaginous yeast biomass can be mixed with other powders and be presented in sachets as a ready-to-mix material (e.g., with water, juice, milk or other liquids). The oleaginous yeast biomass can also be mixed into products such as yogurts.

Oleaginous yeast biomass (predominantly intact or oleaginous yeast flour) can also be packaged in a form combined with other dry ingredients (e.g., sugar, flour, dry fruits, flavorings) and portioned packed to ensure uniformity in the final product. The mixture can then be converted into a food product by a consumer or food service company simply by adding a liquid, such as water or milk, and optionally mixing, and/or cooking without adding oils or fats. In some cases, the liquid is added to reconstitute a dried oleaginous yeast biomass composition. Cooking can optionally be performed using a microwave oven, convection oven, conventional oven, or on a cooktop. Such mixtures can be used for making cakes, breads, pancakes, waffles, drinks, sauces and the like. Such mixtures have advantages of convenience for the consumer as well as long shelf life without refrigeration. Such mixtures are typically packaged in a sealed container bearing instructions for adding liquid to convert the mixture into a food product.

Oleaginous yeast oil for use as a food ingredient is likewise preferably manufactured and packaged under GMP conditions for a food. The yeast oil is typically packaged in a bottle or other container in a similar fashion to conventionally used oils. The container can include an affixed label with directions for using the oil in replacement of conventional oils, fats or eggs in food products, and as a cooking oil. When packaged in a sealed container, the oil has a long shelf-life (at least one year) without substantial deterioration. Unused portions of the oil can be kept longer and with less oxidation if kept cold and/or out of direct sunlight (e.g., within an enclosed space, such as a cupboard). The directions included with the oil can contain such preferred storage information.

Optionally, the oleaginous yeast biomass and/or the yeast oil may contain a food approved preservative/antioxidant to maximize shelf-life, including but not limited to, carotenoids (e.g., astaxanthin, lutein, zeaxanthin, alpha-carotene, beta-carotene and lycopene), phospholipids (e.g., N-acylphosphatidylethanolamine, phosphatidic acid, phosphatidylethanolamine, phosphatidylcholine, phosphatidylinositol and lysophosphatidylcholine), tocopherols (e.g., alpha tocopherol, beta tocopherol, gamma tocopherol and delta tocopherol), tocotrienols (e.g., alpha tocotrienol, beta tocotrienol, gamma tocotrienol and delta tocotrienol), Butylated hydroxytoluene, Butylated hydroxyanisole, polyphenols, rosmarinic acid, propyl gallate, ascorbic acid, sodium ascorbate, sorbic acid, benzoic acid, methyl parabens, levulinic acid, anisic acid, acetic acid, citric acid, and bioflavonoids.

The description of incorporation of predominantly intact biomass, homogenized, or micronized biomass or yeast oil into food for human nutrition is in general also applicable to food products for non-human animals.

The biomass imparts high quality oil or proteins or both in such foods. The content of yeast oil is preferably at least 10 or 20%, 25%, 50% or 75% by weight. Obtaining at least some of the yeast oil from predominantly intact biomass is sometimes advantageous for food for high performance animals, such as sport dogs or horses. Both predominantly intact biomass or lipid rich oleaginous yeast flour can also useful as a preservative. Oleaginous yeast biomass or oil is combined with other ingredients typically found in animal foods (e.g., a meat, meat flavor, fatty acid, vegetable, fruit, starch, vitamin, mineral, antioxidant, probiotic) and any combination thereof. Such foods are also suitable for companion animals, particularly those having an active life style. Inclusion of taurine is recommended for cat foods. As with conventional animal foods, the food can be provided in bite-size particles appropriate for the intended animal.

The following examples are offered to illustrate, but not to limit, the claimed invention.

### V. EXAMPLES

### Example 1

### Cultivation of Oleaginous Yeast

Oleaginous yeast strains used in this and subsequent Examples were obtained from either the Deutsche Sammlung von Mikroorganismen un Zellkulturen GmbH (DSMZ), located at Inhoffenstrabe 7B, 38124 Braunschweig, Germany, or Centraalbureau voor Schimmelscultures (CBS) Fungal Biodiversity Centre located at P.O. Box 85167, 3508 Utrecht, the Netherlands. One hundred eighty five oleaginous yeast strains were screened for growth rate and lipid production.

All strains were rendered axenic via streaking to single colonies on YPD agar (YPD medium as described below with 2% agar added) plates. Single colonies from the YPD plates of each strain was picked and grown to late log phase in YPD medium (10 g bacto-yeast extract, 20 g bacto-peptone and 20 g glucose/1 L final volume in distilled water) on a rotary shaker at 200 rpm at 30° C.

For lipid productivity assessment, 2 mL of YPD medium was added to a 50 mL tared Bioreactor tube (MidSci, Inc.) and inoculated from a frozen stock of each strain. The tubes were then placed in a 30° C. incubator and grown for 24 hours, shaking at 200 rpm to generate a seed culture. After 24 hours, 8 mLs of Y1 medium (Yeast nitrogen base without amino acids, Difco) containing 0.1M phthalate buffer, pH 5.0 was added and mixed well by pipetting gently. The resulting culture was divided equally into a second, tared bioreactor tube. The resulting duplicate cultures of 5 mL each were then placed in a 30° C. incubator with 200 rpm agitation for 5 days. The cells were then harvested for lipid productivity and lipid profile. 3 mL of the culture was used for determination of dry cell weight and total lipid content (lipid productivity) and 1 mL was used for fatty acid profile determination. In either case, the cultures were placed into tubes and centrifuged at 3500 rpm for 10 minutes in order to pellet the cells. After decanting the supernatant, 2 mL of deionized water was added to each tube and used to wash the resulting cell pellet. The tubes were spun again at 3500 rpm for 10 minutes to pellet the washed cells, the supernatant was then decanted and the cell pellets were placed in a −70° C. freezer for 30 minutes. The tubes were then transferred into a lyophilizer overnight to dry. The following day, the weight of the conical tube plus the dried biomass resulting from the 3 mL culture was recorded and the resulting cell pellet was subjected to total lipid extraction using an Ankom Acid Hydrolysis system (according to the manufacturer's instructions) to determine total lipid content.

TABLE 1
Lipid content of oleaginous yeast strains.
Of the 185 strains screened, 17 strains were chosen based on the growth
rate and lipid productivity. The lipid productivity (expressed as percent
lipid of dry cell weight) of these 17 strains are summarized below.

| | Collection | % Lipid |
|---|---|---|
| Species | No. | (DCW) |
| Rhodotorula terpenoidalis | CBS 8445 | 27 |
| Rhodotorula glutinus | DSMZ 70398 | 53.18 |
| Lipomyces tetrasporous | CBS 1810 | 51 |
| Lipomyces tetrasporous | CBS 7656 | 17.63 |
| Lipomyces tetrasporous | CBS 8724 | 18 |
| Cryptococcus curvatus | CBS 5324 | 53 |
| Cryptococcus curvatus | CBS 2755 | 48 |
| Rhodosporidium sphaerocarpum | CBS 2371 | 43 |
| Rhodotorula glutinus | CBS 4476 | 30.97 |
| Lipomyces tetrasporous | CBS 1808 | 29 |
| Trichosporon domesticum | CBS 8111 | 35.16 |
| Trichosporon sp. | CBS 7617 | 40.09 |
| Lipomyces tetrasporous | CBS 5911 | 27.63 |
| Lipomyces tetrasporous | CBS 5607 | 12.81 |
| Cryptococcus curvatus | CBS 570 | 38.64 |
| Cryptococcus curvatus | CBS 2176 | 40.57 |
| Cryptococcus curvatus | CBS 5163 | 35.26 |
| Torulaspora delbruekii | CBS 2924 | 40.00 |
| Rhodotorula toruloides | CBS 8761 | 36.52 |
| Geotrichum histeridarum | CBS 9892 | 33.77 |
| Yarrowia lipolytica | CBS 6012 | 29.21 |
| Geotrichum vulgare | CBS 10073 | 28.04 |
| Trichosporon montevideense | CBS 8261 | 25.60 |
| Lipomyces starkeyi | CBS 7786 | 25.43 |
| Trichosporon behrend | CBS 5581 | 23.93 |
| Trichosporon loubieri var. loubieri | CBS 8265 | 22.39 |
| Rhodosporidium toruloides | CBS 14 | 21.03 |
| Trichosporon brassicae | CBS 6382 | 20.34 |
| Rhodotorula aurantiaca | CBS 317 | 17.51 |
| Sporobolomyces alborubescens | CBS 482 | 10.09 |

Cell pellets resulting from 1 mL culture were subjected to direct transesterification and analysis by GC for fatty acid profile determination. A summary of the fatty acid profiles for each of the above yeast strains are summarized below in Table 2 and the values are expressed in Area percent.

TABLE 2
Fatty Acid profiles of oleaginous yeast strains.

| | Collection | | | | | | | | | | | |
|---|---|---|---|---|---|---|---|---|---|---|---|---|
| Species | No. | C12:0 | C14:0 | C15:0 | C16:0 | C16:1 | C17:0 | C17:1 | C18:0 | C18:1 | C18:2 | >C20 |
| Rhodotorula | CBS 8445 | 0.06 | 0.8 | 0.02 | 27.44 | 0.67 | 0.03 | 0.03 | 5.6 | 59.44 | 3.37 | 2.13 |
| terpenoidalis | | | | | | | | | | | | |
| Rhodotorula | DSMZ | 0.05 | 1.55 | 0.09 | 27.34 | 0.34 | 0.23 | 0.08 | 10.47 | 44.68 | 11.65 | 2.23 |
| glutinus | 70398 | | | | | | | | | | | |
| Lipomyces | CBS 1810 | nd | 0.26 | 0.08 | 24.22 | 2.13 | 0.28 | 0.30 | 9.93 | 55.04 | 4.48 | 3.01 |
| tetrasporous | | | | | | | | | | | | |
| Lipomyces | CBS 7655 | nd | 0.293 | 0.212 | 28.14 | 4.24 | 0.37 | 0.66 | 6.61 | 48.48 | 8.33 | 1.178 |
| tetrasporous | | | | | | | | | | | | |
| Lipomyces | CBS 8724 | nd | 0.27 | 0.08 | 30.69 | 2.12 | 0.27 | 0.24 | 11.8 | 46.71 | 4.26 | 2.89 |
| tetrasporous | | | | | | | | | | | | |
| Cryptococcus | CBS 5324 | nd | 0.27 | 0.22 | 23.31 | 0.49 | 0.12 | 0.09 | 11.55 | 50.78 | 10.80 | 1.61 |
| curvatus | | | | | | | | | | | | |
| Cryptococcus | CBS 2755 | nd | 0.62 | 0.03 | 25.07 | 0.31 | 0.05 | 0.03 | 17.07 | 45.74 | 14.60 | 2.01 |
| curvatus | | | | | | | | | | | | |
| Rhodosporidium | CBS 2371 | 0.03 | 0.68 | 0.03 | 17.86 | 0.13 | 0.54 | 0.17 | 10.4 | 51.01 | 14.60 | 1.82 |
| sphaerocarpum | | | | | | | | | | | | |
| Rhodotorula | CBS 4476 | 0.021 | 0.47 | 0.02 | 24.64 | 0.16 | 0.064 | 0.27 | 13.73 | 42.46 | 16.29 | 1.642 |
| glutinus | | | | | | | | | | | | |
| Lipomyces | CBS 1808 | 0.01 | 0.40 | 0.12 | 26.64 | 3.11 | 0.25 | 0.39 | 7.39 | 54.15 | 3.96 | 2.34 |
| tetrasporous | | | | | | | | | | | | |
| Trichosporon | CBS 8111 | 0.066 | 0.486 | 0.10 | 23.19 | 0.11 | 0.37 | 0.033 | 30.65 | 29.75 | 11.66 | 3.414 |
| domesticum | | | | | | | | | | | | |
| Trichosporon | CBS 7617 | 0.046 | 0.527 | 0.063 | 24.26 | 0.187 | 0.171 | 0.026 | 19.61 | 41.95 | 9.97 | 2.61 |
| sp. | | | | | | | | | | | | |
| Lipomyces | CBS 5911 | 0.017 | 0.45 | 0.16 | 30.79 | 3.56 | 0.29 | 0.48 | 7.77 | 49.99 | 4.40 | 1.433 |
| tetrasporous | | | | | | | | | | | | |
| Lipomyces | CBS 5607 | nd | 0.35 | 0.17 | 37.56 | 3.0 | 0.328 | 0.40 | 9.31 | 42.36 | 4.28 | 1.376 |
| tetrasporous | | | | | | | | | | | | |
| Cryptococcus | CBS 570 | 0.017 | 0.21 | 0.09 | 12.78 | 0.13 | 0.147 | 0.09 | 19.6 | 53.17 | 8.42 | 4.01 |
| curvatus | | | | | | | | | | | | |
| Cryptococcus | CBS 2176 | 0.02 | 0.31 | 0.09 | 19.0 | 0.87 | 0.08 | 0.10 | 7.24 | 60.51 | 9.26 | 2.154 |
| curvatus | | | | | | | | | | | | |
| Cryptococcus | CBS 5163 | 0.019 | 0.34 | 0.06 | 22.7 | 0.70 | 0.13 | 0.10 | 10.65 | 51.36 | 10.34 | 2.24 |
| curvatus | | | | | | | | | | | | |

nd denotes none detected.

Lipid profile analysis was performed on additional strains of oleaginous yeast and several strains were found to produce a high percentage of C16:1 fatty acid including, Torulaspora delbruekii CBS 2924. This oleaginous yeast strain had a lipid productivity of approximately 40% lipid as a percentage of DCW and a fatty acid profile of: C12:0 (0.36%); C14:0 (1.36%); C15:0 (0.16%); C16:0 (10.82%); C 16:1 (42.9%); C17:0 (0.11%); C18:0 (2.1%); C18:1 (35.81%); C18:2 (4.62%). This strain was found to have a particularly high percentage of C16:1 (palmitoleic acid) as part of its fatty acid profile. Four additional strains were identified as producing a high percentage 16:1: Yarrowia lipolytica CBS 6012 (10.10%); Yarrowia lipolytica CBS 6331 (14.80%), Yarrowia lipolytica CBS 10144 (12.90%) and Yarrowia lipolytica CBS 5589 (14.20%, 25%, 50% or 75%). Palmitoleic acid is thought to have a health benefit by signaling to the body to produce less fat.

### Example 2

### Production of Yeast Flour

Rhodotorula glutinis DSMZ-DSM 70398 biomass was produced using fermentation tanks using the following media formulation: KH2PO4 (12.5 g/L); Na2HPO4 (1.0 g/L); yeast extract (Difco) (4.0 g/L); MgSO4.7H₂O (2.50 g/L); CaCl2.2H2O (0.25 g/L); Ammonium sulfate (5.0 g/L); Antifoam 204 (0.26 mL/L) and trace minerals. Initial glucose concentration was approximately 40 g/L. Glucose concentration was monitored throughout the run. When glucose concentration was low, more glucose was added to the fermentation take. After all nitrogen was consumed, the cells began accumulating lipid. Samples of biomass were taken throughout the run to monitor lipid levels and the run was stopped when the biomass reached the desired lipid content (over 30% lipid by dry cell weight). In this case, the oleaginous yeast biomass was harvested when it reached approximately 44% lipid by dry cell weight.

To process the high lipid content oleaginous yeast biomass for food applications, the harvested Rhodotorula glutinis biomass was separated from the culture medium and then concentrated using centrifugation. Deionized water was added to the yeast concentrate to bring the solids content of the suspension to approximately 20%, 25%, 50% or 75%. This material was then dried on a drum dryer according to standard methods. The drum dried yeast was then suspended in deionized water to a solids content of 33%. The suspension was then processed through a GEA “Panada” lab homogenizer twice, each time at 1,200 Bar. This high lipid content oleaginous yeast dispersion was used to in the subsequent food applications, including drying into an oleaginous yeast flour.

### Example 3

### Food Applications Using High Lipid Content Oleaginous Yeast

A yellow cake formulation was made with yeast biomass. Rhodotorula glutinis DSMZ-DSM 70398 biomass (approximately 44% lipid by dry cell weight) was prepared according to the methods described in Example 2. A 33% solids yeast biomass dispersion in deionized water was prepared and used in the following formulation for yellow cake: all-purpose wheat flour (54.6 g); granulated sugar (46.28 g); whole milk (21.33 g); water (4.77 g); yeast dispersion (35.55 g); salt (0.77 g); baking powder (1.7 g); vanilla extract (1.33 g); natural flavor (0.33 g); and egg white (12.55 g). The flour, salt and baking powder were weighed and sifted together to combine and set aside. The yeast dispersion was combined with the sugar, whisked and the water was added and whisked again. The natural flavor and vanilla were then added to the yeast/sugar mixture. The flour mixture and milk were added to the yeast/sugar mixture alternatively while mixing. The batter was then poured into lined muffin tins.

A control yellow cake was also prepared using the following formulation: all-purpose flour (51.43 g); granulated sugar (45.77 g); whole milk (18.86 g); eggs (20.93 g); butter (30.86 g); baking powder (1.7 g); vanilla extract (1.16 g); and salt (0.79 g). The flour, salt and baking powder were dry blended and then set aside. The butter was beat with a mixer until thick and creamy and then the sugar was added to the butter and creamed until homogenous. The eggs were slowly added while mixing until a thick emulsion was formed. The vanilla was added and then milk and flour was added alternatively while mixing. The batter was then poured into lined muffin tins.

Both the control yellow cake and the yeast-containing yellow cake were baked in a preheated 325° F. oven for 12-15 minutes (until a inserted toothpick came out clean). The pans were rotated after 8 minutes.

Both cakes (control and yeast-containing) had similar rise and good crumb structure. In this particular application, the lipid-rich oleaginous yeast biomass was used in place of butter and egg yolks, demonstrating the successful use of lipid-rich oleaginous yeast biomass in a food application.

### Example 4

### Mechanical Extraction of Oil from Oleaginous Yeast Biomass

Yeast strain Rhodotorula glutinis (DSMZ-DSM 70398) was obtained from the Deutsche Sammlung von Mikroorganismen and Zellkulturen GmbH (German Collection of Microorganism and Cell Culture, Inhoffenstraβe 7B, 38124 Braunschweig, Germany. Cryopreserved cells were thawed and added to 50 mL YPD media (described above) with 1×DAS vitamin solution (1000×: 9 g/L tricine; 0.67 g/L thiamine-HCl; 0.01 g/L d-biotin; 0.008 cyannocobalamin; 0.02 calcium pantothenate; and 0.04 g/L p-Aminobenzoic acid) and grown at 30° C. with 200 rpm agitation for 18-24 hours until an OD reading was over 5 OD (A600). The culture was then transferred to 7-L fermentors and switched to YP1 medium (8.5 g/L Difco Yeast Nitrogen Base without Amino Acids and Ammonium Sulfate, 3 g/L Ammonium Sulfate, 4 g/L yeast extract) with 1×DAS vitamin solution. The cultures were sampled twice per day and assayed for OD (A600), dry cell weight (DCW) and lipid concentration. When the cultures reached over 50 g/L DCW, the cultures were harvested. Based on dry cell weight, the yeast biomass contained approximately 50% oil.

Oleaginous yeast strain Rhodotorula glutinis (DSMZ-DSM 70398) was cultured according to the methods in Example 1 to produce oleaginous yeast biomass with approximately 50% lipid by DCW. The harvested yeast broth was dried using three different methods for comparison: (1) tray dried in a forced air oven at 75° C. overnight; (2) dried on a drum dryer without concentration; and (3) the yeast broth was concentrated to 22% solids and the slurry was then dried on a drum dryer. Material from each of the three different drying conditions was heat conditioned and fed through a screw press for oil extraction. The press temperature was at 150° F. and the conditioned dried yeast biomass was held at about 190° F. until it was ready to be fed into the press.

The moisture content of the drum dried yeast broth without concentration was 5.4% and the drum dried yeast was then conditioned in an oven at 90° C. for 20 minutes. The moisture content after conditioning was 1.4%. The conditioned drum dried yeast was then fed into a bench-top Taby screw press for oil extraction. This material oiled well, with minimal footing.

The moisture content of the drum dried concentrated yeast broth was 2.1% and the drum dried concentrated yeast was then conditioned in an oven at 90° C. for 20 minutes. The moisture content after conditioning was 1.0%. The conditioned drum dried concentrated yeast was then fed into a bench-top Taby screw press for oil extraction. This material oiled well, with minimal footing.

### Example 5

### Oleaginous Yeast Growth on Cellulosic Sugars and Carbon Utiltization Screen

To assess if oleaginous yeast can grow on saccharified cellulosic sugars from cornstover, sorghum, Miscanthus or beet pulp, Rhodotorula glutinis (DSMZ-DSM 70398) were grown in YPD medium (described in Example 1) with 4% glucose at 30° C. with 200 rpm agitation overnight. This seed culture was then split into conditions containing 4% saccharified cellulosic sugars from cornstover, sorghum, Miscanthus, or beet pulp. Glucose condition was included as a positive control. The flasks were then grown at 30° C. with 200 rpm agitation for six days. The sugar concentration in the flasks was monitored daily and the flasks were fed to maintain a sugar level of 25 g/L. At the end of the sixth day, the cells were harvested and growth was determined. Rhodotorula glutinis was able to grow on all of the cellulosic sugars at a level that was either similar or better than the glucose control.

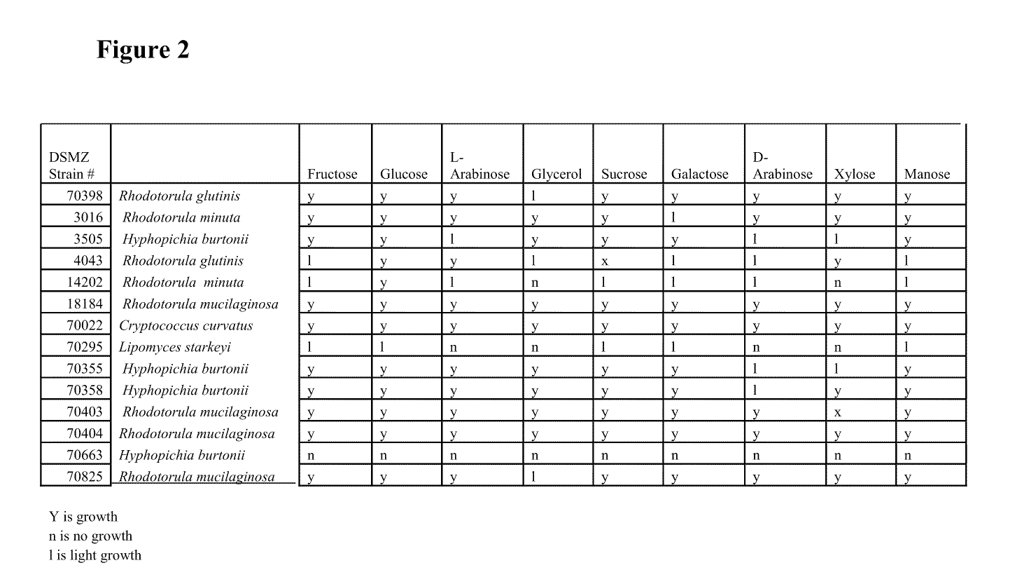

Additionally, carbon utilization screens were performed using agar plate assays using the method described in Example 1 above. The following oleaginous yeast strains were used in the screen: Rhodotorula glutinis (DSMZ-DSM 70398); Rhodotorula minuta (DSMZ-DSM 3016); Hyphopichia burtonii (DSMZ-DSM 3505); Rhodotorula glutinis (DSMZ-DSM 4043); Rhodotorula minuta (DSMZ-DSM 14202); Rhodotorula mucilaginosa (DSMZ-DSM 18184); Cryptococcus curvatus (DSMZ-DSM 70022); Lipomyces starkeyi (DSMZ-DSM 70295); Hyphopichia burtonii (DSMZ-DSM 70355); Hyphopichia burtonii (DSMZ-DSM 70358); Rhodotorula mucilaginosa (DSMZ-DSM 70403); Rhodotorula mucilaginosa (DSMZ-DSM 70404); Hyphopichia burtonii (DSMZ-DSM 70663); and Rhodotorula mucilaginosa (DSMZ-DSM 70825). The oleaginous yeast strains were screened for growth on agar plates containing 1% (w/v) of one of the following carbon sources: fructose, glucose, L-arabinose, glycerol, sucrose, galactose, D-arabinose, xylose and mannose. Each of the oleaginous yeast strains were streaked out onto a plate containing each of the carbon sources. The plates were allowed to grow at 30° C. for 7 days. At the end of seven days, the plates were checked visually for growth. The results of this assay are summarized in FIG. 2.

### Example 6

### Genotyping Oleaginous Yeast Strains

Genotyping of 48 different strains of oleaginous yeast was performed. Genomic DNA was isolated from each of the 48 different strains of oleaginous yeast biomass as follows. Cells (approximately 200 mg) were centrifuged from liquid cultures 5 minutes at 14,000×g. Cells were then resuspended in sterile distilled water, centrifuged 5 minutes at 14,000×g and the supernatant discarded. A single glass bead ˜2 mm in diameter was added to the biomass and tubes were placed at −80° C. for at least 15 minutes. Samples were removed and 150 μl of grinding buffer (1% Sarkosyl, 0.25 M Sucrose, 50 mM NaCl, 20 mM EDTA, 100 mM Tris-HCl, pH 8.0, RNase A 0.5 ug/ul) was added. Pellets were resuspended by vortexing briefly, followed by the addition of 40 ul of 5M NaCl. Samples were vortexed briefly, followed by the addition of 66 μl of 5% CTAB (Cetyl trimethylammonium bromide) and a final brief vortex. Samples were next incubated at 65° C. for 10 minutes after which they were centrifuged at 14,000×g for 10 minutes. The supernatant was transferred to a fresh tube and extracted once with 300 μl of Phenol:Chloroform:Isoamyl alcohol 12:12:1, followed by centrifugation for 5 minutes at 14,000×g. The resulting aqueous phase was transferred to a fresh tube containing 0.7 vol of isopropanol (˜190 μl), mixed by inversion and incubated at room temperature for 30 minutes or overnight at 4° C. DNA was recovered via centrifugation at 14,000×g for 10 minutes. The resulting pellet was then washed twice with 70% ethanol, followed by a final wash with 100% ethanol. Pellets were air dried for 20-30 minutes at room temperature followed by resuspension in 50 μl of 10 mM TrisCl, 1 mM EDTA (pH 8.0).

Five μl of total algal DNA, prepared as described above, was diluted 1:50 in 10 mM Tris, pH 8.0. PCR reactions, final volume 20 μl, were set up as follows. Ten μl of 2× iProof HF master mix (BIO-RAD) was added to 0.4 μl primer SZ5434 forward primer (5′ GTCCCTGCCCTTTGTACACAC-3′ (SEQ ID NO.:1) at 10 mM stock concentration) and 0.4 μl primer SZ5435 reverse primer (5′-TTGATATGCTTAAGTTCAGCGGG-3′ (SEQ ID NO:2) at 10 mM stock concentration). The primers were selected based on sequence conservation between three prime regions of 18S and five prime regions of fungal 26S rRNA genes. By reference, the forward primer is identical to nucleotides 1632-1652 of Genbank Ascension # AY550243 and the reverse primer is identical to nucleotides 464271-464293 of Genbank Ascension # NC_{—}001144. Next, 5 μl of diluted total DNA and 3.2 μl dH₂O were added. PCR reactions were run as follows: 98° C., 45″; 98° C., 8″; 53° C., 12″; 72° C., 20″ for 35 cycles followed by 72° C. for 1 min and holding at 25° C. For purification of PCR products, 20 μl of 10 mM Tris, pH 8.0, was added to each reaction, followed by extraction with 40 μl of Phenol:Chloroform:isoamyl alcohol 12:12:1, vortexing and centrifuging at 14,000×g for 5 minutes. PCR reactions were applied to S-400 columns (GE Healthcare) and centrifuged for 2 minutes at 3,000×g. The resulting purified PCR products were cloned and transformed into E. coli using ZeroBlunt PCR4Blunt-TOPO vector kit (Invitrogen) according to manufacture's instructions. Sequencing reactions were carried out directly on ampicillin resistant colonies. Purified plasmid DNA was sequenced in both directions using M13 forward and reverse primers.

A list of the 48 strains of oleaginous yeast that were genotyped is summarized below in Table 3 along with their SEQ ID NOs.

TABLE 3
Genotyped oleaginous yeast strains.

| Strain Name | Strain Number | SEQ ID NO |
|---|---|---|
| Rhodotorula glutinis | DSMZ-DSM | SEQ ID NO: 3 |
| | 7098 | |
| Lipomyces tetrasporus | CBS 5911 | SEQ ID NO: 4 |
| Rhodotorula glutinis var. glutinis | CBS 3044 | SEQ ID NO: 5 |
| Lipomyces tetrasporus | CBS 8664 | SEQ ID NO: 6 |
| Lipomyces tetrasporus | CBS 1808 | SEQ ID NO: 7 |
| Lipomyces tetrasporus | CBS 1810 | SEQ ID NO: 7 |
| Lipomyces starkeyi | CBS 1809 | SEQ ID NO: 8 |
| Trichosporon montevideense | CBS 8261 | SEQ ID NO: 9 |
| Yarrowia lipolytica | CBS 6331 | SEQ ID NO: 10 |
| Cryptococcus curvatus | CBS 5324 | SEQ ID NO: 11 |
| Rhodotorula mucilaginosa var. | CBS 316 | SEQ ID NO: 12 |
| mucilaginosa | | |
| Cryptococcus curvatus | CBS 570 | SEQ ID NO: 11 |
| Cryptococcus curvatus | CBS 2176 | SEQ ID NO: 11 |
| Cryptococcus curvatus | CBS 2744 | SEQ ID NO: 11 |
| Cryptococcus curvatus | CBS 2754 | SEQ ID NO: 11 |
| Cryptococcus curvatus | CBS 2829 | SEQ ID NO: 11 |
| Cryptococcus curvatus | CBS 5163 | SEQ ID NO: 11 |
| Cryptococcus curvatus | CBS 5358 | SEQ ID NO: 11 |
| Trichosporon sp. | CBS 7617 | SEQ ID NO: 13 |
| Sporobolomyces alborubescens | CBS 482 | SEQ ID NO: 14 |
| Rhodotorula glutinis var. glutinis | CBS 324 | SEQ ID NO: 15 |
| Rhodotorula glutinis var. glutinis | CBS 4476 | SEQ ID NO: 16 |
| Trichosporon behrend | CBS 5581 | SEQ ID NO: 17 |
| Geotrichum histeridarum | CBS 9892 | SEQ ID NO: 18 |
| Rhodotorula aurantiaca | CBS 8411 | SEQ ID NO: 19 |
| Cryptococcus curvatus | CBS 8126 | SEQ ID NO: 20 |
| Trichosporon domesticum | CBS 8111 | SEQ ID NO: 21 |
| Rhodotorula toruloides | CBS 8761 | SEQ ID NO: 22 |
| Rhodotorula terpendoidalis | CBS 8445 | SEQ ID NO: 23 |
| Yarrowia lipolytica | CBS 10144 | SEQ ID NO: 24 |
| Rhodotorula glutinis var. glutinis | CBS 5805 | SEQ ID NO: 25 |
| Yarrowia lipolytica | CBS 10143 | SEQ ID NO: 26 |
| Lipomyces tetrasporus | CBS 5607 | SEQ ID NO: 27 |
| Yarrowia lipolytica | CBS 5589 | SEQ ID NO: 28 |
| Lipomyces tetrasporus | CBS 8724 | SEQ ID NO: 29 |
| Rhodosporidium sphaerocarpum | CBS 2371 | SEQ ID NO: 30 |
| Trichosporon brassicae | CBS 6382 | SEQ ID NO: 31 |
| Cryptococcus curvatus | CBS 2755 | SEQ ID NO: 32 |
| Lipomyces tetrasporus | CBS 7656 | SEQ ID NO: 33 |
| Lipomyces starkeyi | CBS 7786 | SEQ ID NO: 34 |
| Yarrowia lipolytica | CBS 6012 | SEQ ID NO: 35 |
| Trichosporon loubieri var. loubieri | CBS 8265 | SEQ ID NO: 36 |
| Geotrichum vulgare | CBS 10073 | SEQ ID NO: 37 |
| Rhodosporidium toruloides | CBS 14 | SEQ ID NO: 38 |
| Rhodotorula glutinis var. glutinis | CBS 6020 | SEQ ID NO: 39 |
| Lipomyces orientalis | CBS 10300 | SEQ ID NO: 40 |
| Rhodotorula aurantiaca | CBS 317 | SEQ ID NO: 41 |
| Torulaspora delbruechii | CBS 2924 | SEQ ID NO: 42 |

U.S. Provisional Patent application No. 61/105,121, filed Oct. 14, 2008, entitled “Food Compositions of Microalgal Biomass”; U.S. Provisional application No. 61/157,187, filed Mar. 3, 2009, entitled “Food Compositions of Microalgal Biomass”; U.S. Provisional application No. 61/173,166, filed Apr. 27, 2009, entitled, “Food Compositions of Microalgal Biomass”; U.S. Provisional Application 61/246,070, filed Sep. 25, 2009, entitled, “Food Compositions of Microalgal Biomass” are hereby each incorporated by reference in their entirety for all purposes. PCT Patent application No. PCT/US2009/60692, filed Oct. 14, 2009, entitled, “Food Compositions of Microalgal Biomass” is hereby incorporated by reference in its entirety for all purposes. U.S. patent application Ser. No. 12/579,091, filed on Oct. 14, 2009, entitled “Food Compositions of Microalgal Biomass”; U.S. patent application Ser. No. 12/684,884, filed Jan. 8, 2010, entitled, “Microalgal Flour”; U.S. patent application Ser. No. 12/684,885, filed Jan. 8, 2010, entitled “Microalgae-Based Beverages”; U.S. patent application Ser. No. 12/684,886, filed Jan. 8, 2010, entitled “Healthier Baked Goods Containing Microalgae”; U.S. patent application Ser. No. 12/684,887, filed Jan. 8, 2010, entitled “Reduced Fat Foods Containing High-Lipid Microalgae With Improved Sensory Properties”; U.S. patent application Ser. No. 12/684,888, filed Jan. 8, 2010, entitled, “Egg Products Containing Microalgae”; U.S. patent application Ser. No. 12/684,889, filed Jan. 8, 2010, entitled, “Reduced Pigmentation Microalgae Strains and Products Therefrom”; U.S. patent application Ser. No. 12/684,891, filed Jan. 8, 2010, entitled, “Gluten-free Foods Containing Microalgae”; U.S. patent application Ser. No. 12/684,892, filed Jan. 8, 2010, entitled, “Methods of Inducing Satiety”; U.S. patent application Ser. No. 12/684,893, filed Jan. 8, 2010, entitled, “High Protein and High Fiber Algal Materials; and U.S. patent application Ser. No. 12/684,894, filed Jan. 8, 2010, entitled, “Edible Oil and Processes for Its Production from Microalgae” are hereby each incorporated by reference in their entirety for all purposes. U.S. Provisional Patent Application No. 61/324,286, filed Apr. 14, 2010, entitled “Fuel and Chemical Production from Oleaginous Yeast,” U.S. Provisional Patent Application No. 61/324,294, filed Apr. 14, 2010, entitled “Lipid-Rich Microalgal Flour Food Compositions,” and PCT Patent Application No. PCT/US2010/031088, filed Apr. 14, 2010, entitled “Novel Microalgal Food Compositions” are hereby incorporated by reference in their entirety for all purposes.

All references cited herein, including patents, patent applications, and publications, are hereby incorporated by reference in their entireties, whether previously specifically incorporated or not. The publications mentioned herein are cited for the purpose of describing and disclosing reagents, methodologies and concepts that may be used in connection with the present invention. Nothing herein is to be construed as an admission that these references are prior art in relation to the inventions described herein.

Although this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

What is claimed is:

1. A food composition comprising at least 0.1% w/w oleaginous yeast biomass and one or more other ingredient, wherein the oleaginous yeast biomass comprises at least about 20% oil by dry weight.

2. The food composition of claim 1, comprising more than 1% oleaginous yeast biomass.

3. The food composition of claim 1, wherein the oleaginous yeast biomass is predominantly intact cells.

4. The food composition of claim 1, wherein the oleaginous yeast biomass is predominantly lysed cells.

5. The food composition of claim 4, wherein the oleaginous yeast biomass is a homogenate.

6. The food composition of claim 5, wherein the oleaginous yeast biomass is a powder.

7. The food composition of claim 4, wherein the biomass is in the form of a powder, and wherein the oleaginous yeast biomass comprises at least about 30% oleaginous yeast oil by dry weight.

8. The food composition of claim 1, that is a salad dressing, egg product, baked good, bread, bar, snack chip, pasta, sauce, soup, beverage, frozen dessert, comminuted meat, butter or spread.

9. The food composition of claim 1, wherein the average size of particles in the oleaginous yeast flour is less than about 100 μm.

10. A method of making a food composition comprising combining oleaginous yeast biomass comprising at least about 20% by weight oleaginous yeast oil with at least one other ingredient.

11. A method of making a food composition, the method comprising the steps of:
a. determining the amount of non-oleaginous yeast oil, non-oleaginous yeast fat or egg in a conventional food product; and
b. replacing all or a portion of the non-oleaginous yeast oil, non-oleaginous yeast fat or egg or supplementing the non-oleaginous yeast oil, non-oleaginous yeast fat or egg with a specified amount of oleaginous yeast biomass.

12. The method of claim 11, wherein no non-oleaginous yeast oil, non-oleaginous yeast fat or egg is added to the food composition.

13. The method of claim 11, wherein the amount of oleaginous yeast biomass is from about 0.25 times to about 4 times the mass or volume of the non-oleaginous yeast oil, non-oleaginous yeast fat or egg in the conventional food product.

14. The food composition of claim 1, wherein the oleaginous yeast biomass is a yeast of the Dikarya subkingdom.

15. The food composition of claim 1, wherein the oleaginous yeast biomass comprises oil having a lipid profile comprising at least 20% C16:1.

16. The food composition of claim 15, wherein the oleaginous yeast biomass comprises oil having a lipid profile comprising at least 40% C16:1.
